(19) United States
(12) Patent Application Publication
(10) Pub. No.: US 2013/0282406 A1
(43) Pub. Date: Oct. 24, 2013

(54) APPARATUS, METHOD AND ARTICLE TO AUTOMATE AND MANAGE ELECTRONIC DOCUMENTS IN A NETWORKED ENVIRONMENT

(71) Applicants: Eric William Snyder, Sammamish, WA (US); Steven Preston Finch, Tampa, FL (US); Hon Seng Long, Redmond, WA (US); Lloyd Sutton Hawes, II, Seattle, WA (US)

(72) Inventors: Eric William Snyder, Sammamish, WA (US); Steven Preston Finch, Tampa, FL (US); Hon Seng Long, Redmond, WA (US); Lloyd Sutton Hawes, II, Seattle, WA (US)

(21) Appl. No.: 13/451,136

(22) Filed: Apr. 19, 2012

(51) Int. Cl. G06Q 40/08

(52) U.S. Cl. 705/4

(57) ABSTRACT

Systems and methods automate and manage electronic communications in the insurance industry, particularly between agents/brokers and insurance companies/insurers. Such include a collaboration environment to collaborate on electronic documents and messages. A user interface may selectively present changes to electronic documents (e.g., forms) to underwriters based on a number of criteria. Criteria may include a status of a job (e.g., proposal for a policy) for the respective underwriter. Changes to proposed policy terms, conditions and forms may be eliminated for underwriters who have either declined to underwrite the policy or have already been bound for the policy. Underwriters conveniently have access to correspondence and electronic documents on a policy-by-policy or consumer-by-consumer basis.

### BACKGROUND

1. Technical Field

The present disclosure generally relates to networked systems and methods, and in particular to systems and methods for communications between devices operated by agents of an insurance agency and devices operated by employees or contractors of insurance carriers, underwriters or insurers.

2. Description of the Related Art

The insurance industry typically includes a variety of entities which cooperate to provide various types of insurance products or policies. Entities are typically grouped into three principal types, based on their respective roles: 1) insurance carriers or underwriters, 2) insurance agencies or brokerages with their associated agents or brokers, and 3) consumers, policyholders or insureds. Each of these entities may be of various sizes, from individuals to large businesses (e.g., tens or hundreds of thousands of employees).

The insurance carriers or underwriters, commonly referred to as insurers, underwrite the risk or eventuality that is being insured against. The insurers are typically relatively large companies, with deep financial resources. Insurers may be stock companies or alternatively mutual companies (i.e., owned by policyholders). Insurers may be for profit or not for profit companies. Insurers often are classified based on the type of insurance they underwrite. The two fundamental classifications are life insurance companies and non-life, general or property/casualty insurance companies.

Insurance agencies or brokerages initially market insurance to consumers. Insurance agencies or brokerages are typically business entities with one to hundreds or even more agents or brokers. Agencies or agents may in some instances be captive, writing only for one insurer. Alternatively, agencies or brokerages may be independent, writing policies for two more different insurers. Agents or brokers may work directly for the agency or brokerage, as employees, or may work as independent contractors. In some uses, the term agency is used to refer to those entities which owe allegiance to the insurance carrier, underwriter or insurer, while the term brokerage is used to refer to those entities that owe allegiance to the consumer, policyholder or insured.

Agents or brokers typically interact directly with the consumers. Agents or brokers may assist consumers in identifying risks, developing risk management strategies, and selecting amongst various policy options. Policy options may include one or more layers of excess or surplus lines of insurance policies, over and above a primary insurance policy. Agents or brokers may obtain raw data from consumers, complete required forms, and/or solicit one or more insurers to underwrite the policy or policies. The forms are often highly complex, and would be difficult, if not impossible for most consumers to complete.

Each consumer may have very different insurance requirements from those of other consumers. For example, individual or family consumers or insureds may require relatively simple life, health, disability, automobile, homeowners and/or renters insurance policies. Business consumers or insureds may require relatively simple general insurance policies and/or more complicated insurance policies. Thus a large variety of forms are required to cover the insurance needs of the various types of consumers, from individuals, families, small businesses or other organizations, to very large multi-national companies with disparate operations dispersed across multiple regions and/or countries.

Individual insurers may issue policies only in distinct lines of business. For example, property and casualty lines of business may include: fire, allied lines, farm owners multiple, homeowner's multiple, commercial multiple (i.e., general), commercial lines, mortgage guaranty, ocean marine, inland marine, financial guaranty, medical malpractice, earthquake, group accident and health, credit accident and health, other accident and health, workers compensation, other liabilities, product liability, auto liability, auto physical damage, aircraft, fidelity, surety, glass, burglary and theft, boiler and machinery, credit, and international, to name a few. Such may be the result of a level of expertise or comfort of the insurer with a particular type of risk. Such may also be the result of limitations placed on the insurer by various regulatory agencies (e.g., insurance commission) and associated laws and rules. Thus, not all insurers are willing or even capable of underwriting all types of risks.

Fulfilling the requirements of any single consumer may require insurance policies underwritten by two or more insurers. Thus, fulfilling the requirements of a single consumer may require an agent or broker to interact with two or more insurers. Fulfilling the requirements of multiple consumers typically requires the agent or broker to interact with two or more insurers.

Agents or brokers typically interact with a subset of all individuals who represent the insurers, referred to herein as underwriters. Such interactions may take a substantial amount of both the agent or broker's workday, as well as that of the underwriter. Automating and managing those interactions may advantageously increase the efficiency of both the agent and the broker, as well as the underwriter, allowing more work to be accomplished in a given amount of time than might otherwise be accomplished. Such may also reduce or eliminate errors, and may result in real savings to the various entities.

### BRIEF SUMMARY

More flexible approaches to electronic or digital communications in the insurance industry are desirable. Particularly desirable are approaches that accommodate the specific needs of various entities, while automating and managing certain aspects of the interaction between the entities. Often agents and brokers want the freshest quotes on a policy as possible. This creates a small window of time in which the agent or broker has to solicit quotes or commitments from potential underwriters or insurers. It is in the best interests of the consumer, policyholder or insured to get competitive quotes from the widest variety and number of underwriters or insurers as possible. The automated systems and methods described herein help to facilitate such.

Agents, brokers and underwriters handle large volumes of information. Reducing the clutter can enhance efficiency and shorten the time it takes to evaluate a policy and provide a quote.

Systems and methods automate and manage electronic communications in the insurance industry, particularly between agents/brokers and insurance companies/insurers. Such include a collaboration environment to collaborate on electronic documents and messages. A user interface may selectively present changes to electronic documents (e.g., forms) to underwriters based on a number of criteria. Criteria may include a status of a job (e.g., proposal for a policy) for the respective underwriter. Changes to proposed policy terms, conditions and forms may be eliminated for underwriters who have either declined to underwrite the policy or have already been bound for the policy. Underwriters conveniently have access to correspondence and electronic documents on a policy-by-policy or consumer-by-consumer basis.

A method of operation in an insurance management system to manage communications between devices operated by a number of agents or brokers of each of a plurality of insurance agencies or brokerages and devices operated by a number of underwriters of each of a plurality of insurance carriers, the insurance management system including at least one processor, at least one nontransitory computer-readable medium communicatively coupled to the at least one processor, and a plurality of communications ports to provide communications with the devices operated by the underwriters and the agents or brokers may be summarizes as including detecting a change to at least one electronic document related to a proposed policy at the insurance management system; for each of a plurality of underwriters, reviewing a respective status of the underwriter with respect to the proposed policy via the at least one processor; automatically determining, by the at least one processor, which of the plurality of underwriters to update which the change to the electronic document based at least in part on the respective status of the underwriter with respect to the proposed policy; and conditionally automatically propagating the change to the electronic document only to the determined underwriters by the at least one processor.

Detecting a change to at least one electronic document related to a proposed policy may include receiving a change from one of the devices operated by one or the agents or brokers, and conditionally propagating the change to the electronic document only to the determined underwriters may include propagating the change to a number of the devices operated by the underwriters. Reviewing a respective status of the underwriter with respect to the proposed policy via the at least one processor may include determining whether the underwriter has declined the policy. Reviewing a respective status of the underwriter with respect to the proposed policy via the at least one processor may include determining whether the underwriter has already been bound with respect to the policy. Conditionally propagating the change to the electronic document only to the determined underwriters by the at least one processor may include pushing an electronic document with changes to only the determined underwriters and not to any other of the plurality of underwriters. Conditionally propagating the change to the electronic document only to the determined underwriters by the at least one processor may include electronically notifying the determined underwriters of an availability of the changed electronic document and not any other of the plurality of underwriters. Conditionally propagating the change to the electronic document only to the determined underwriters by the at least one processor may include propagating a new version of the electronic document, the new version including the change.

The method of operation in an insurance management system to manage communications between devices operated by a number of agents or brokers of each of a plurality of insurance agencies or brokerages and devices operated by a number of underwriters of each of a plurality of insurance carriers, the insurance management system including at least one processor, at least one nontransitory computer-readable medium communicatively coupled to the at least one processor, and a plurality of communications ports to provide communications with the devices operated by the underwriters and the agents or brokers may further include causing a display of a number of user selectable icons which allow an end user to select among a plurality of versions of the electronic document.

Causing a display of a number of user selectable icons which allow an end user to select among a plurality of versions of the electronic document may include providing a markup language page from the insurance management system to at least one of the devices operated by at least one of the determined underwriters.

The method of operation in an insurance management system to manage communications between devices operated by a number of agents or brokers of each of a plurality of insurance agencies or brokerages and devices operated by a number of underwriters of each of a plurality of insurance carriers, the insurance management system including at least one processor, at least one nontransitory computer-readable medium communicatively coupled to the at least one processor, and a plurality of communications ports to provide communications with the devices operated by the underwriters and the agents or brokers may further include causing a display of a number of user selectable icons in a document panel of a user interface which allow an end user to select among a plurality of versions of the electronic document; the document panel displayed concurrently with a message panel of the user interface.

The method of operation in an insurance management system to manage communications between devices operated by a number of agents or brokers of each of a plurality of insurance agencies or brokerages and devices operated by a number of underwriters of each of a plurality of insurance carriers, the insurance management system including at least one processor, at least one nontransitory computer-readable medium communicatively coupled to the at least one processor, and a plurality of communications ports to provide communications with the devices operated by the underwriters and the agents or brokers may further include, in response to a movement of a user interface element that represents a changed version of the electronic document to a defined area of a user interface for posting documents, automatically determining which of the plurality of underwriters with which a previous version of the electronic document has been shared for the proposed policy, before reviewing the respective status of each of the underwriters with respect to the proposed policy.

An insurance management system to manage communications between devices operated by a number of agents or brokers of each of a plurality of insurance agencies or brokerages and devices operated by a number of underwriters of each of a plurality of insurance carriers, the insurance management system including at least one processor, at least one nontransitory computer-readable medium communicatively coupled to the at least one processor, and a plurality of communications ports to provide communications with the devices operated by the underwriters and the agents or brokers may be summarized as including at least one processor; at least one nontransitory computer-readable medium communicatively coupled to the at least one processor, and a plurality of communications ports to provide communications with the devices operated by the underwriters and the agents or brokers, wherein: the insurance management system detects a change to at least one electronic document related to a proposed policy at the insurance management system; for each of a plurality of underwriters, the at least one processor reviews a respective status of the underwriter with respect to the proposed policy via the at least one processor; the at least one processor automatically determine which of the plurality of underwriters to update which the change to the electronic document based at least in part on the respective status of the underwriter with respect to the proposed policy; and the insurance management system conditionally automatically propagates the change to the electronic document only to the determined underwriters.

The insurance management system may receive the detected change from one of the devices operated by one or the agents or brokers, and may propagate the change to a number of the devices operated by the underwriters. The at least one processor may determine whether the underwriter has declined the policy to, at least in part, review the respective status of the underwriter with respect to the proposed policy. The at least one processor may determine whether the underwriter has already been bound with respect to the policy to review the respective status of the underwriter with respect to the proposed policy. The insurance management system may push an electronic document with changes to only the determined underwriters and not to any other of the plurality of underwriters. The insurance management system may electronically notify the determined underwriters of an availability of the changed electronic document and not any other of the plurality of underwriters. The insurance management system may propagate a new version of the electronic document, the new version including the change. The insurance management system may further cause a display of a number of user selectable icons which allow an end user to select among a plurality of versions of the electronic document. The insurance management system may further provide a markup language page from the insurance management system to at least one of the devices operated by at least one of the determined underwriters. The insurance management system may further cause a display of a number of user selectable icons in a document panel of a user interface which allow an end user to select among a plurality of versions of the electronic document; the document panel displayed concurrently with a message panel of the user interface. In response to a movement of a user interface element that represents a changed version of the electronic document to a defined area of a user interface for posting documents, the at least one processor may automatically determine which of the plurality of underwriters with which a previous version of the electronic document has been shared for the proposed policy, before the at least one processor reviews the respective status of each of the underwriters with respect to the proposed policy.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a networked insurance industry environment according to one illustrated embodiment, including an insurance management system; a plurality of agencies or brokerages, each with associated devices to provide communications via the insurance management system; and a plurality of insurance companies, underwriters or insurers, each with associated devices to provide communications via the insurance management system.

FIG. 2 is a functional block diagram of an insurance management system networked to an agent or broker operated processor-based device and an insurer underwriter operated processor-based device, according to one illustrated embodiment.

FIG. 3 is a screen print of a first portion of a user interface particularly illustrating a settings panel as used by a first agent or broker of a first agency or brokerage, according to one illustrated embodiment.

FIG. 4 is a screen print of the second portion of a user interface particularly illustrating a documents and message panel as used by the first agent or broker of the first agency or brokerage, according to one illustrated embodiment.

FIG. 5A is a screen print of a third portion of a user interface as used by a first underwriter of a first insurer, according to one illustrated embodiment.

FIG. 5B is a screen print of a fourth portion of a user interface particularly illustrating pre-selected previous submissions for which to provide an update including a new version of a document as used by the first agent or broker of the first agency or brokerage, according to one illustrated embodiment.

FIG. 6 is a schematic diagram showing an agent or broker or an agency or brokerage using a workspace to electronically communicate with an insurance management system electronically communicate with a number of underwriters of a number of insurers, according to one illustrated embodiment.

FIG. 7 is a schematic diagram of a portion of a database stored to a nontransitory computer- or processor-readable medium, including a number of data structures useful in implementing the operation of the insurance management system, according to one illustrated embodiment.

FIG. 8 is a flow diagram showing a high level method of operation of an insurance management system to automate and/or manage communications between one or more agents or brokers and one or more underwriters of a number of insurers, according to one illustrated embodiment.

FIG. 9 is a flow diagram showing a low level method of operation of an insurance management system to automate and/or manage communications between one or more agents or brokers and one or more underwriters of a number of insurers, according to one illustrated embodiment.

FIG. 10 is a flow diagram showing a method of operation of an insurance management system to provide electronic documents to one or more underwriters of a number of insurers, according to one illustrated embodiment.

FIG. 11 is a flow diagram showing a method of operation of an insurance management system to provide notifications regarding electronic documents to one or more underwriters of a number of insurers, according to one illustrated embodiment.

FIG. 12 is a flow diagram showing a method of operation of an insurance management system to propagate versions of documents, according to one illustrated embodiment.

FIG. 13 is a flow diagram showing a method of operation of an insurance management system to enable selection of electronic documents, according to one illustrated embodiment.

FIG. 14 is a flow diagram showing a method of operation of an insurance management system to display a message panel and enable selection of electronic documents, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, server computers, and/or communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The terms agency and brokerage, as well as related terms such as agent and broker, are used interchangeably herein, to refer to the entity that interacts with the consumer, policyholder or insured.

The term consumer is used herein to refer to a potential purchaser of insurance, as well as to an entity that has an existing insurance policy in place or bound (i.e., policyholder or insured). The terms policyholder and insured are used herein interchangeably to refer to an entity with an existing insurance policy in place or bound.

The terms insurance carriers or insurer are used interchangeably herein to refer entities that underwrite the risk or eventually that is being insured against, by issuance of one or more insurance policies. While the term underwriter is commonly used to refer to a person or business entity that engages in the insurance business, to avoid confusion the term underwriter will be used herein and in the claims to refer to an individual who assesses risks and/or determines premiums in their work for an insurer.

The headings and Abstract of the Disclosure provided herein are for convenience only and do not interpret the scope or meaning of the embodiments.

This disclosure describes various systems, methods and articles related to electronic commerce and in particular evaluation of affiliates in electronic commerce. While specific structures and acts associated with particular illustrated embodiments are disclosed, other structures and acts may be employed in other embodiments.

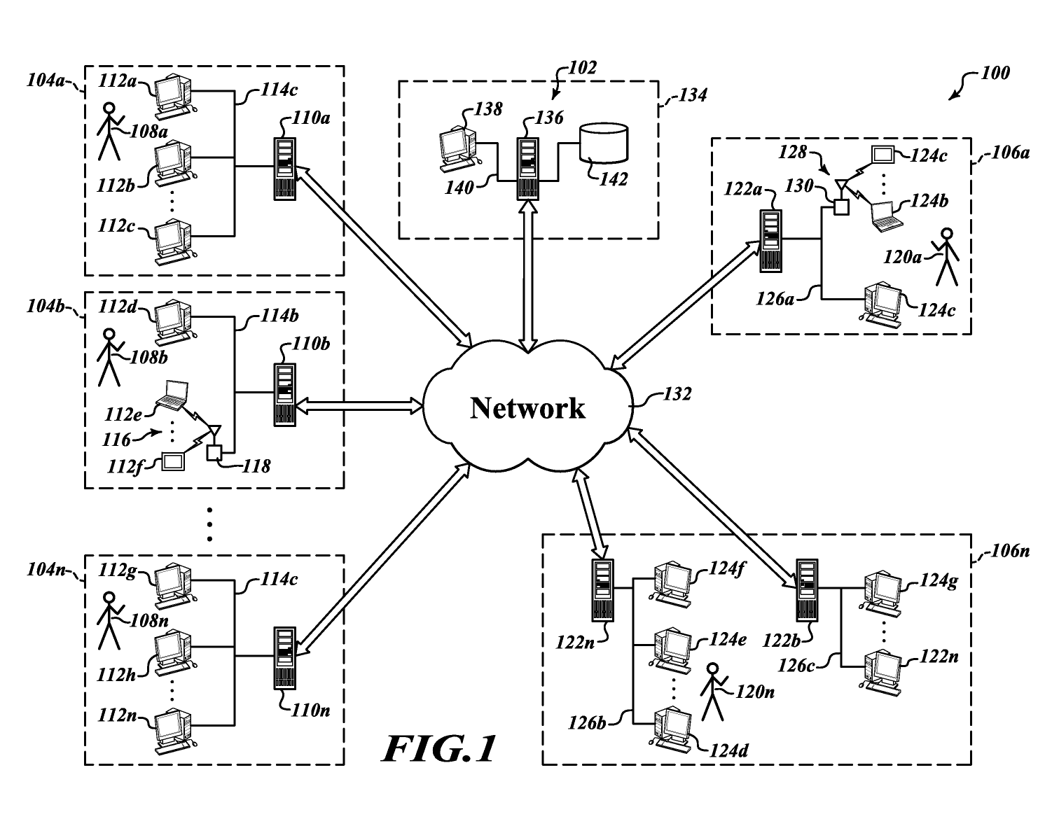

FIG. 1 shows a networked insurance industry environment 100, according to one illustrated embodiment.

The networked insurance industry environment 100 includes an insurance management system 102, a plurality of agencies or brokerages 104a, 104b-104n (three shown, collectively 104), and a plurality of insurance carriers, underwriters or insurers 106a-106n (two shown, collectively 106).

The agencies or brokerages 104 may take any variety of forms, for example, being of any of a variety of sizes (e.g., one to hundreds of agents or brokers). The agencies or brokerages 104 will typically be independent, that is capable of writing policies underwritten by various ones of the insurers 106. Each agency or brokerage 104 will typically have one or more agents or brokers 108a, 108b-108n (one agent or broker per agency shown, collectively 108). As described in the background section, agents or brokers 108 typically interact directly with the consumer, policyholder or insured (not illustrated).

Each agency or brokerage 104 may have one or more server computers 110a, 110b-110n (only one per agency 104 shown, collectively 110) to provide electronic communications either externally from and/or internally within the agency or brokerage 104. Agencies or brokerages 104 may often have more than one server computer system 110, particularly where the size of the agency or brokerage 104 or the amount of business handled by the agency or brokerage 104 justifies a larger number of server computer systems 110. Each agency or brokerage 104 may have a number of processor-based devices 112a, 112b, 112c, 112d, 112e, 112f, 112g, 112h-112n (three shown per agency 104, collectively 112). The processor-based devices 112 may take a variety of forms which allow input and output by an end user (e.g., agent or broker 108). For example, the processor-based devices may take the form of personal computers 112a-112d, 112g-112n, laptop or notebook computers 112e, or tablet computers 112f. The processor-based devices 112 may be communicatively coupled to the respective server computers 110 via one or more networks, for example, one or more wired (e.g., electrical conductors, optical fibers) networks 114a, 114b-114n (only one per agency or brokerage 104 shown, collectively 114) and/or wireless networks 116 (only one shown) via one or more wireless access points 118 (only one shown).

The insurers 106 may take any variety of forms, typically constituting a relatively large organization. As explained in the background section, each insurer 106 may provide or underwrite insurance policies on some subset of all possible lines of business. Each insurer 106 may typically have one or more underwriters 120a, 120n (one underwriter per insurer 106 shown, collectively 120). The underwriters 120 typically interact directly with the agents or brokers 108, assess risks and/or determine premiums.

Each insurer 106 may have one or more server computers 122a, 122b-122n (three shown, collectively 122) to provide electronic communications either externally from and/or internally within the insurer 106. Given the size of most insurers 106, insurers will typically have more than one server computer system 122. Each insurer 106 may have a number of processor-based devices 124a, 124b, 124c, 124d, 124e, 124f, 124g-124n (eight shown, collectively 124). The processor-based devices 124 may take a variety of forms which allow input and output by an end user (e.g., underwriter 108). For example, the processor-based devices may take the form of personal computers 124a, 124d-124n, laptop or notebook computers 124b, or tablet computers 124c. The processor-based devices 124 may be communicatively coupled to the respective server computers 110 via one or more networks, for example one or more wired networks 114a, 114b-114n (only one per insurer 106 shown, collectively 114) and/or wireless networks 128 (only one shown) via one or more wireless access points 130 (only one shown).

The insurance management system 102 operates as an intermediary between the processor-based devices 112 of the agencies or brokerages 104 and the processor-based devices 124 of the insurers 106, electronically communicating over one or more networks, for example, over a wide area network 132 such as the Internet or an extranet. The insurance management system 102 may be operated by a separate entity 134 from the agencies or brokerages 104 and insurers 106, ensuring fair access to all parties.

The insurance management system 102 may have one or more server computers 136 (only one illustrated) to provide electronic communications either externally from and/or internally within the entity 134. To handle the load of multiple agencies or brokerages 104 and multiple insurers 106, the insurance management system 102 will typically have more than one server computer system 136. The insurance management system 102 may include one or more terminals or personal computers 138 (only one shown), communicatively coupled to the server computer 136 via one or more wired or wireless networks 140 (only one shown). The terminals or personal computers 138 allow input and output by an end user (e.g., employee or contractor of the entity 134).

The insurance management system 102 includes at least one nontransitory computer- or processor readable storage medium 142. The nontransitory computer- or processor readable storage medium 142 stores a variety of information about the agencies or brokerages 104, agents or brokers 108, insurers 106 and/or underwriters 120, facilitating the automation and management of communications therebetween, including the transmission of electronic correspondence including electronic messages and/or electronic or digital documents.

At times it may be necessary or desirable to share some or all of the electronic or digital documents or files between one or more of the entities (e.g., agencies or brokerages 104, insurers 106, and/or consumers, policyholders or insureds (not shown). Sharing the electronic or digital documents or files may include allowing interactions with such files, for example, viewing, modifying, copying, annotating, importing, and/or deleting. Additionally, or alternatively, it may be desirable to change ownership for one or more of the electronic or digital documents or files. The terms electronic and digital are used interchangeably herein and in the claims. For example, such terms are used to modify the noun “document,” to indicate a set of data that is in a format suitable for use by a processor-based device, for storage in computer- or processor-readable form, or for transmission via a communications network. As used herein and in the claims, the term “document” includes single page or multiple page documents, whether in the form of a text or alphanumeric based binary file (e.g., ASCII, or .doc, .docx, .xlb file extensions), in the form of an image (e.g., binary image, vector based image, Portable Data File or PDF®) of a text, alphanumeric or graphic based document, or in the form of a markup language based file (e.g., HTML, XML).

In some implementations, the nontransitory computer- or processor readable storage medium 142 may constitute a common electronic document repository to store electronic or digital documents or files. As used herein and in the claims, the term “common electronic document repository” means electronic or digital document or file storage media which is shared by two or more networked nodes, such as two or more servers 110, 122 associated with agencies or brokerages 104 and/or insurers 106, and hence is common to at least two network nodes. The common electronic document repository may be implemented in one or across more than one computer- or processor-readable storage media (e.g., write once read many). The common electronic document repository may include one or more databases which state information or data regarding the electronic or digital documents or files. Such database(s) may be stored separately from the electronic or digital documents, for example, on storage medium that may be rewritten many times (e.g., hard drive, RAID, RAM). The common electronic document repository may be co-located with the insurance management system 102, for example in the same room, building or facility. Alternatively, the common electronic document repository may be located remotely from the insurance management system 102, for example in a different facility, city, state or country. Electronic or digital documents or files are collections of information stored at specific locations in non-transitory computer- or processor-readable media, thus are logically addressable portions of such media, which may or may not be contiguous.

While FIG. 1 illustrates a representative networked insurance industry environment, typical networked insurance industry environments may include many additional computer systems and entities. The concepts taught herein may be employed in a similar fashion with more populated networked insurance industry environments.

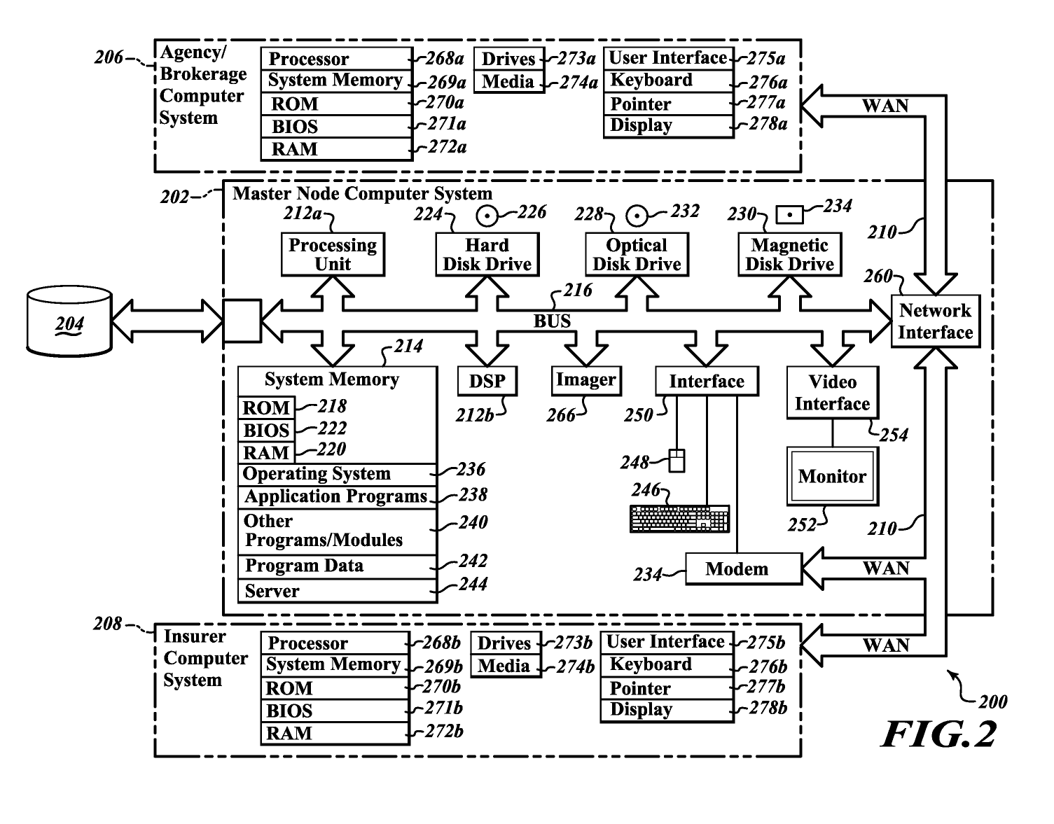

FIG. 2 and the following discussion provide a brief, general description of a suitable networked insurance industry environment 200 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments, as well as other embodiments, can be practiced with other system configurations and/or other computing system configurations, including hand-held devices, multiprocessor systems, microprocessor-based or programmable consumer electronics, personal computers (“PCs”), networked PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices or media.

FIG. 2 shows a networked insurance industry environment 200 comprising one or more insurance management system server computer systems 202 (only one illustrated) and one or more associated nontransitory computer- or processor readable storage medium 204 (only one illustrated). The associated nontransitory computer- or processor readable storage medium 204 is communicatively coupled to the insurance management system server computer system(s) 202 via one or more communications channels, for example, one or more parallel cables, serial cables, or wireless channels capable of high speed communications, for instance via Firewire®.

The networked insurance industry environment 200 also comprises one or more agency or brokerage associated computer systems 206 (only one illustrated) and one or more insurance carrier or insurer associated computer systems 208 (only one illustrated). The agency or brokerage associated computer systems 206 and the insurance carrier or insurer associated computer systems 208 are communicatively coupled to the insurance management system server computer system(s) 202 by one or more communications channels, for example one or more wide area networks (WANs) 210. In operation, the agency or brokerage associated computer systems 206 and/or the insurance carrier or insurer associated computer systems 208 typically function as either a server to other end user computer systems (i.e., clients) associated with a respective entity (e.g., agency, brokerage, insurer) or function as end user computer systems (i.e., clients) themselves. In operation, the insurance management system server computer system(s) 202 typically functions as a server with respect to the agency or brokerage associated computer systems 206 and/or the insurance carrier or insurer associated computer systems 208.

The networked insurance industry environment 200 may employ other computer systems and network equipment, for example, additional servers, proxy servers, firewalls, routers and/or bridges. The insurance management system server computer system(s) 202 will at times be referred to in the singular herein, but this is not intended to limit the embodiments to a single device since in typical embodiments there may be more than one insurance management system server computer system(s) 202 involved. Unless described otherwise, the construction and operation of the various blocks shown in FIG. 2 are of conventional design. As a result, such blocks need not be described in further detail herein, as they will be understood by those skilled in the relevant art.

The insurance management system server computer system(s) 202 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and/or a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the master node server computer system 202, such as during start-up.

The insurance management system server computer system(s) 202 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable media 226, 232, 234, provide nonvolatile storage of computer-readable instructions, data structures, program modules and other data for the master node server computer system 202. Although the depicted insurance management system server computer system(s) 202 is illustrated employing a hard disk 224, optical disk 228 and magnetic disk 230, those skilled in the relevant art will appreciate that other types of computer-readable media that can store data accessible by a computer may be employed, such as WORM drives, RAID drives, magnetic cassettes, flash memory cards, digital video disks (“DVD”), Bernoulli cartridges, RAMs, ROMs, smart cards, etc.

Program modules can be stored in the system memory 214, such as an operating system 236, one or more application programs 238, other programs or modules 240 and program data 242. Application programs 238 may include instructions that cause the processor(s) 212 to automatically store to the associated nontransitory computer- or processor readable storage medium 204 logical relationships between identifiers associated with agents and/or brokers and identifiers associated with selected underwriters of insurers. Application programs 238 may include instructions that cause the processor(s) 212 to automatically control access to certain information based on certain criteria. For example, the instructions may limit agents or brokers from seeing information about a specific underwriter of an insurer, unless the agent or broker has previously identified the specific underwriter. Application programs 238 may include instructions that cause the processor(s) 212 to automatically send, transmit, transfer, or otherwise provide electronic communications from an agent or broker to a set of underwriters of an insurer based on sets of underwriters defined or identified as affiliated by or with the agent or broker. Such may include sending, transmitting, transferring or otherwise providing access to electronic or digital documents or files to the set of underwriters of an insurer defined or identified as affiliated by or with the particular agent or broker. Such may allow an agent or broker to seamlessly automatically distribute electronic communications and documents, for instance, a request for a policy quote along with supporting data and/or documentation, to a plurality of different underwriters of insurers with which the agent or broker has an existing defined relationship. Different sets of underwriters may be configured for various specific lines of business which are handled by the respective underwriters or their associated insurers. Thus, an agent or broker may affiliate a first set of underwriters for a first line of business or lines of business, and may affiliate a second set of underwriters for a second line of business or lines of business. Application programs 238 may include instructions that cause the processor(s) 212 to automatically establish, maintain, update or record relationship or affiliation information. Such may include logical relationships between agents or brokers and affiliated underwriters of insurers. Such may include relationships between underwriters and insurers, for instance adding new underwriter as they are hired by an insurer or deleting old underwriters as they leave the employ of the insurer. Such may include relationships between agents or brokers and agencies or brokerages, for instance, adding new agents or brokers as they are hired by an agency or brokerage or deleting old agents or brokers as they leave the employ of the agency or brokerage. Such may include updating records in a database or table. Application programs 238 may include instructions that cause the processor(s) 212 to automatically establish, maintain, update or record ownership information with respect to electronic or digital documents or files, as well as privileges, permissions or authorizations to perform various acts on such electronic or digital documents or files such as reading, modifying, annotating, importing, and/or deleting. Application programs 238 may even further include instructions to create entries in and/or query one or more databases which store information or data about agencies, agents or brokers, insurer, underwriters of insurers, and/or the electronic or digital documents or files, regardless of location at which those electronic or digital documents are stored. Other program modules 240 may include instructions for handling security such as password or other access protection and communications encryption. The system memory 214 may also include communications programs, for example, a server 244 that causes the master node server computer system 202 to serve electronic or digital documents or files via corporate intranets, extranets, or other networks as described below. The server 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of suitable severs may be commercially available such as those from Mozilla, Google, Microsoft and Apple Computer.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the management system server computer system(s) 202 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The insurance management system server computer system(s) 202 can include other output devices, such as speakers, printers, etc.

The insurance management system server computer system(s) 202 can operate in a networked environment using logical connections to one or more remote computers and/or devices. For example, the insurance management system server computer system(s) 202 can operate in a networked environment using logical connections to one or more agency or brokerage associated computer systems 206 and the insurance carrier or insurer associated computer systems 208. Communications may be via a wired and/or wireless network architecture, for instance, wired and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the insurance management system server computer system(s) 202, the agency or brokerage associated computer systems 206 and the insurance carrier or insurer associated computer systems 208.

The agency or brokerage associated computer systems 206 and the insurance carrier or insurer associated computer systems 208 will typically take the form of end user processor-based devices, for instance, personal computers (e.g., desktop or laptop computers), netbook computers, tablet computers and/or smart phones and the like, executing appropriate instructions. These end user processor-based devices may be communicatively coupled to one or more server computers. For instance, agency or brokerage devices may be communicatively coupled externally from the respective agency or brokerage via one or more agency or brokerage server computers, which may implement a firewall. For instance, insurer devices may be communicatively coupled externally from the respective insurer via one or more insurer server computers, which may implement a firewall. The server computers may execute a set of server instructions to function as a server for a number of end user computer systems (i.e., clients) communicatively coupled via a LAN at a facility or site. The end user computer systems 206, 208 may execute a set of client instructions to function as a client of the server computer(s), which are communicatively coupled via a WAN.

The agency or brokerage associated computer systems 206 and the insurance carrier or insurer associated computer systems 208 may include one or more processing units 268a, 268b (collectively 268), system memories 269a, 269b (collectively 269) and a system bus (not shown) that couples various system components including the system memory 269 to the processing unit 268. The agency or brokerage associated computer systems 206 and the insurance carrier or insurer associated computer systems 208 will at times each be referred to in the singular herein, but this is not intended to limit the embodiments to a single agency or brokerage associated computer system 206 and/or the insurance carrier or insurer associated computer systems 208. In typical embodiments, there may be more than one agency or brokerage associated computer systems 206 and there will likely be a large number of insurance carrier or insurer associated computer systems 208.

The processing unit 268 may be any logic processing unit, such as one or more central processing units (CPUs), digital signal processors (DSPs), application-specific integrated circuits (ASICs), field programmable gate arrays (FPGAs), etc. Non-limiting examples of commercially available computer systems include, but are not limited to, an 80x86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. Unless described otherwise, the construction and operation of the various blocks of the satellite node server computer systems 206 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270a, 270b (collectively 270) and random access memory (“RAM”) 272a, 272b (collectively 272). A basic input/output system (“BIOS”) 271a, 271b (collectively 271), which can form part of the ROM 270, contains basic routines that help transfer information between elements within the end user computer systems 206, 208, such as during start-up.

The agency or brokerage associated computer systems 206 and the insurance carrier or insurer associated computer systems 208 may also include one or more media drives 273a, 273b (collectively 273), e.g., a hard disk drive, magnetic disk drive, WORM drive, and/or optical disk drive, for reading from and writing to computer-readable storage media 274a, 274b (collectively 274), e.g., hard disk, optical disks, and/or magnetic disks. The computer-readable storage media 274 may, for example, take the form of removable media. For example, hard disks may take the form of a Winchester drives, and optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program modules and other data for the agency or brokerage associated computer systems 206 and/or the insurance carrier or insurer associated computer systems 208. Although described as employing computer-readable storage media 274 such as hard disks, optical disks and magnetic disks, those skilled in the relevant art will appreciate that end user computer systems 206, 208 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, electronic or digital documents or files or data (e.g., metadata, ownership, authorizations) related to such can be stored in the computer-readable storage media 274.

Program modules, such as an operating system, one or more application programs, other programs or modules and program data, can be stored in the system memory 269. Program modules may include instructions for accessing a Website, extranet site or other site or services (e.g., Web services) and associated WebPages, other pages, screens or services hosted by the insurance management system 102. Program modules may include instructions for storing certain or selected electronic correspondence and/or electronic or digital documents or files or changes thereto to nontransitory computer- or processor readable storage medium, such as local media 274a, 274b, or remote media 142 (FIG. 1), 204, 226, 232, 234. Alternatively, the instructions may cause retrieval of electronic correspondence and/or electronic or digital documents or files or changes to existing electronic correspondence and/or electronic or digital documents or files. Program modules may additionally include instructions for handling security such as ownership, password or other access protection and communications encryption.

In particular, the system memory 269 may include communications programs that permit the agency or brokerage associated computer systems 206 and the insurance carrier or insurer associated computer systems 208 to retrieve electronic correspondence and/or electronic or digital documents or files from the associated nontransitory computer- or processor-readable storage medium 204. The system memory 269 may additionally include communications programs that permit the agency or brokerage associated computer systems 206 and the insurance carrier or insurer associated computer systems 208 to gain access to or retrieve electronic correspondence and/or electronic or digital documents or files from the local electronic document repository 204 of another satellite node, via the insurance management system server computer system(s) 202, if the requesting agency or brokerage associated computer systems 206 and the insurance carrier or insurer associated computer systems 208 have sufficient right, permission, privilege or authority. The system memory 269 may also include other communications programs, for example, a Web client or browser that permits the agency or brokerage associated computer systems 206 and the insurance carrier or insurer associated computer systems 208 to access and exchange data with sources such as Web sites of the Internet, corporate intranets, extranets, or other networks. The browser may, for example, be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 269, the operating system, application programs, other programs/modules, program data and/or browser can be stored on the computer-readable storage media 274 of the media drive(s) 273. An operator can enter commands and information into the agency or brokerage associated computer systems 206 and the insurance carrier or insurer associated computer systems 208 via a user interface 275a, 275b (collectively 275) through input devices such as a touch screen or keyboard 276a, 276b (collectively 276) and/or a pointing device 277a, 277b (collectively 277) such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278a, 278b (collectively 278) may be coupled to the system bus via a video interface, such as a video adapter. The satellite node server computer system 206 can include other output devices, such as speakers, printers, etc.

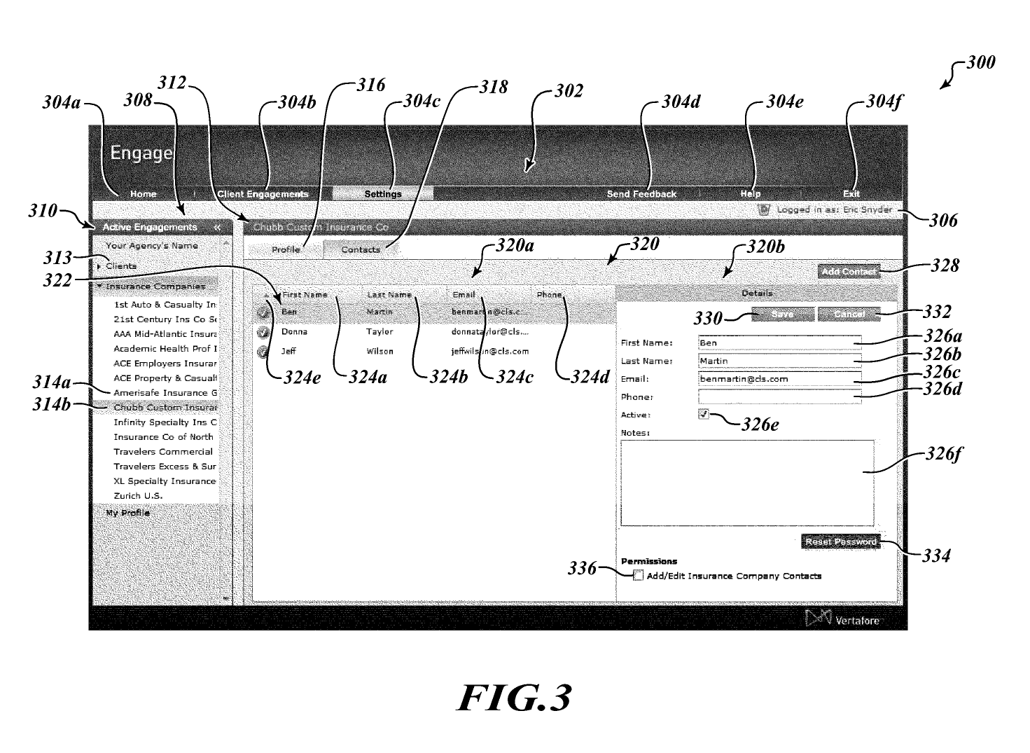

FIG. 3 shows a first portion 300 of a user interface particularly illustrating a settings panel as used by a first agent or broker of a first agency or brokerage, second agent or broker of a second agency or brokerage, and third agent or broker of a third agency or brokerage, respectively, according to one illustrated embodiment.

The first portion 300 of the user interface may be presented as a window or screen with a number of user interface components, for instance, menus, panels, dialog boxes, radio buttons, expansion controls and plus/minus icons (i.e., icons the selection of which cause a hierarchical list to expand and contract). The terms window and screen are used interchangeably herein to refer to a portion of a user interface (e.g., graphical user interface or GUI), which is displayed on a display or monitor and which provides information (i.e., output) to a user and which may allow the user to provide instructions, commands or information (i.e., input) to a processor-based device or an application executing on a processor-based device.

Many of the user interface components of the first portion 300 of the user interface illustrated in FIG. 3 are identical to one another, the differences being solely in the content of material displayed in or by the various components. Thus, identical or similar components are identified with the same reference numbers across the figures. Only significantly different components are called out with separate reference numbers.

The first portion 300 includes a main menu 302 with a number of user selectable icons or tabs, collectively 304, and a user field 306 that indicates an identity of the user currently logged in to use the system. The main menu 302 may include a home tab user selectable icon or tab 304a, client engagement user selectable icon or tab 304b, settings user selectable icon or tab 304c, send feedback user selectable icon or tab 304d, help user selectable icon or tab 304e, and exit user selectable icon or tab 304f. The user may choose any of the user selectable icon or tabs 304 by selecting the desired user selectable icon or tab with a pointer, for example, by manipulating a mouse, trackpad or trackball, touching a touch sensitive display, or tabbing using an appropriate tab key on a keyboard or keypad, or by speaking commands.

Selection of the home user selectable icon or tab 304a causes presentation of a home panel (not shown for agents/brokers). The home panel may provide user interface tools for constructing, transmitting, and/or receiving correspondence such as electronic mail messages and electronic documents. Such may allow an agent or broker to provide the content (e.g., text of message) of the correspondence, identify, attach or provide links to supporting electronic documents (e.g., spreadsheets, PDF documents, images), and specify intended recipients for the electronic correspondence. For example, where correspondence is a request for policy pricing, the correspondence may set out certain details of the policy (e.g., size, amount, length) and may attach one or more electronic documents related to the same request. The electronic documents may, for instance, provide data or information that supports the request.

The user interface may include one or more elements that allow the agent or broker to specify one or more subjects for the correspondence, for instance, one or more lines of business to which the correspondence pertains. This may allow the system to automatically determine or identify intended recipients for the correspondence. For example, the system may identify all insurer underwriters with which the particular agent or broker has an existing defined logical relationship and who handle the particular lines of business specified. The system may rely on the database schema 700 in assessing such, and running appropriate queries against the information in the database.

Selection of the send feedback icon or tab 304d causes presentation of a feedback panel (not shown), allowing the agent or broker to send, transmit, transfer or otherwise make available feedback to one or more intended recipients (e.g., to a vendor or support entity responsible for creation, maintenance, improvements and/or support of the insurance management system).

Selection of the help icon or tab 304e causes presentation of a help panel or dialog box (not shown), allowing the agent or broker to enter a subject or topic of an inquiry regarding use of the insurance management system to receive help, assistance or pointers.

Selection of the exit icon or tab 304f causes termination of the insurance management system on the specific end user processor-based device.

Selection of the settings icon or tab 304c causes presentation of a settings panel 308 (illustrated in FIG. 3). The settings panel 308 allows the agent or broker to set or modify settings. The settings panel 308 may be composed of a number of subpanels. In particular, the settings panel 308 may include an active engagement subpanel 310 and an insurer specification subpanel 312.

The active engagement subpanel 310 provides a set of user selectable client icons 313 (shown collapsed) which identify and correspond to a number of clients of the agent or broker or of the agency or brokerage. The set of client icons 313 displayed to any given end user (e.g., agent or broker), may be customized for the particular end user. For example, the client icons 313 may identify each client, customer or potential customer who has an existing relationship with an agent or broker, or with an agency or brokerage for which the particular end user works. Selection of a user selectable expand/collapse icon (i.e., [symbol] , ▾) toggles between presenting and hiding the set of client icons 313.

The active engagement subpanel 310 provides a set of user selectable insurer icons 314a, 314b (shown expanded, only two called out, collectively 314) which identify and correspond to a number of insurers. The set of insurer icons 314 displayed to any given end user (e.g., agent or broker), may be customized for the particular end user. For example, the insurer icons 314 may identify each insurer that has an existing relationship with an agency or brokerage for which the particular end user works. This allows the end user to easily identify potential insurers from whom to solicit bids or policies. Selection of a user selectable expand/collapse icon (i.e., [symbol] , ▾) toggles between presenting and hiding the set of insurer icons 314. Selection of a user selectable hide/show icon (i.e., <<) toggles between presenting and hiding the active engagement subpanel 310. The active engagement subpanel 310 may additionally appear or be presented in other panels such as panels presented under the home tab icon or tab 304a and/or under the client engagement icon or tab 304b. Selection of one of the insurer icons 314 updates the content of the insurer specification subpanel 312, which displays insurer specific information.

The insurer specification subpanel 312 includes a number of tabs. In particular, the insurer specification subpanel 312 may include a profile tab 316 and a contacts tab 318.

User selection of the contacts tab 318 brings up a contacts subpanel 320, which includes a list portion 320a and a details portion 320b.

The list portion 320a provides a listing of all contacts 322 (only one called out) at the selected insurer that have a defined logical relationship with the specific end user. The list portion 320a may have a number of fields, collectively 324, which specify information regarding each contact. The fields 324 may, for example, include a first name field 324a that specifies a first name, surname field 324b that specifies a surname, electronic mail address field 324c that specifies an electronic mail address, phone number field 324d that specifies a phone number, and an indication of status field 324e that specifies a current status (e.g., active, inactive) of the contact.

The details portion 320b may include a number of user fillable fields collectively 326 for specifying information about a contact. User fillable fields 326 may include a first name field 326a to specify a first name, surname field 326b to specify a surname, electronic mail address field 326c to specify an electronic mail address, telephone number field 326d to specify a phone number, a status check box 326e to specify a status (e.g., active, inactive) of the contact, and notes field 326f which allows freeform input of notes regarding the contact. The end user may use the details portion 320b to create new logical affiliation relationships with underwriters of insurers, for example, by selecting an add contact icon 328 after completing at least some of the fields 326. Additionally, the end user may use the details portion 320b to modify or update information about existing (i.e., previously created logical affiliation relationships with underwriters) contacts, for example, by selection of a save icon 330 after modifying information in one or more of the fields 326. Selection of a cancel icon 332 allows the user to revert back to original information after changing the information in one or more of the fields 326 without saving the changed information.

Selection of a reset password icon 334 allows an end user to reset his password. Selection may bring up a dialog box with two or three fields. Two fields may be for the user to specify the new password. The content of the fields may be checked to ensure that the user has correctly typed his new password, before changing the password at a system level. An optional third field may be for the user to specify an existing password. Such may ensure that a mischievous passerby does not attempt to change another user's password on finding a computer on which the other user is currently logged in when such other user is not physically present.

Selection of a permissions check box 336 may control permission for others to modify contacts (e.g., underwriter) for the particular end user (e.g., agent, broker).

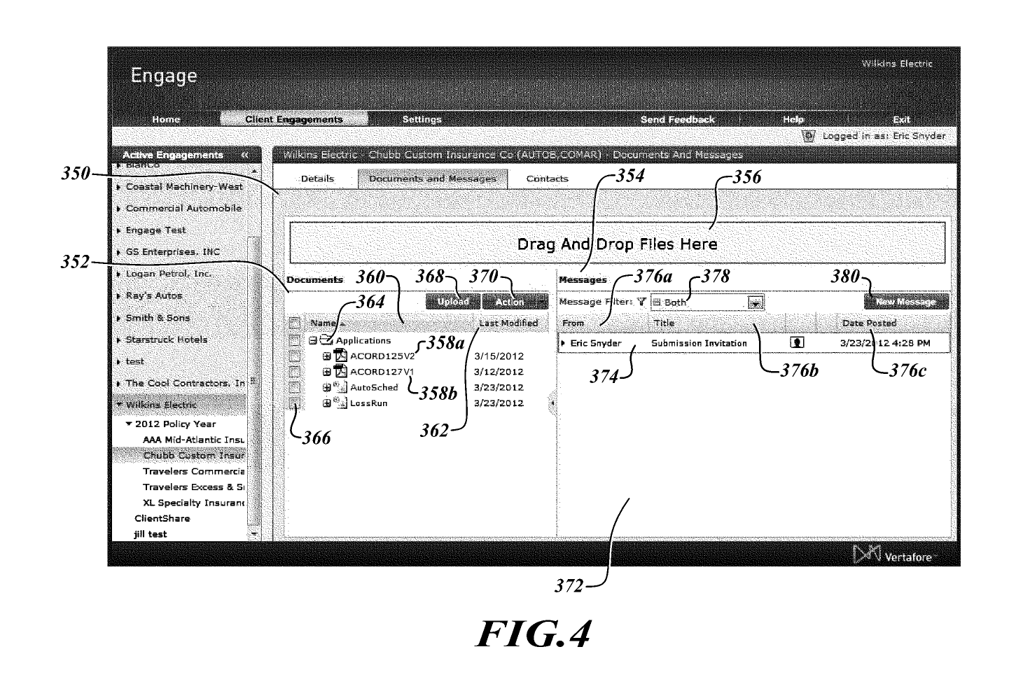

FIG. 4 shows a second portion of a user interface particularly illustrating a documents and messages panel 350, according to one illustrated embodiment.

Some of the user interface components of the third portion 340 of the user interface illustrated in FIG. 4 are identical or similar to user interface components of the first portion 300 of the user interface illustrated in FIG. 3. The identical or similar components are identified with the same reference numbers in FIG. 4 as were employed in FIG. 3. Description of identical or similar components will not be repeated, in the interest of brevity. Only significantly different components are called out with separate reference numbers and discussed below.

User selection of a client listed under one of the set of user selectable client icons 313 (shown collapsed in FIG. 3) which identify and correspond to a number of clients of the agent or broker or of the agency or brokerage brings up a list of engagements associated with the selected client in the active engagements panel 310. Selection of one of these active engagements in the active engagements panel 310 brings up the documents and messages panel 350. The documents and messages panel 350 may include a number of subpanels, for example, a document subpanel 352 and a messages subpanel 354, as well as a drag and drop area 356.

The document subpanel 352 provides a set of user selectable document icons 358a, 358b (only two called out, collectively 358). The user selectable document icons 358 correspond to each of a number of electronic documents which are associated with the specified consumer, policyholder or project. The electronic documents may include one or more versions of a single electronic document. For example, a list or set of documents may include an initial or original electronic document, 358b, as well as a newer changed or revised electronic document 358a, which includes changes or revisions to the initial or original electronic document 358b. The most recent version may be identified, for example, visually. For instance, the most recent version may appear at a top of the list, or at a highest level of a nested hierarchy of various versions of the electronic document. Other visual effects such as color, highlighting, marqueeing and/or flashing may be employed. Visual effects may be displayed on the icon corresponding to the most recent version of the electronic document or spatially proximate thereto.

The electronic documents may take a variety of forms useful in assessing, supporting or otherwise documenting the evaluation, consideration, or assessment of whether to bind a policy, and the specific particulars of such policy such as limits, deductibles, exclusions, endorsements, etc. The document subpanel 352 may include a name field 360 and a date field 362. The name field 360 may indicate a name of the specific document, while the date field 362 may indicate a date on which the specific document was last modified, and/or a date on which the specific document was created.

The user selectable document icons 358 may be arranged in a hierarchical fashion, such as in one or more folders 364 (one called out) of a nested folder structure. As previously noted, various versions of a document may be hierarchically arranged from most recent to oldest. Selection of a user selectable expand/collapse icon (i.e., +, −) toggles between expanding and collapsing the contents of folders 364.

Selection of an electronic document, for example, by double clicking with a cursor positioned on a corresponding electronic document icon, may cause the specific electronic documents to be opened in an appropriate viewer (e.g., word processing program, spreadsheet program, image viewer program).

Selection of a corresponding checkbox 366 (only one called out) allows a user to select one or more documents for the insurance managements system to perform one or more actions on the selected documents or folders including, but not limited to, adding a new version, copying, or deleting the selected document. Additional actions which may not be related to a corresponding checkbox 366 may include, but are not limited to, the insurance management system organizing or enabling organization of a folder structure in which to organize documents (e.g., by adding a new folder or folder structure in which to organize documents or removing folders). Clicking the Upload icon 368 allows a user to choose and upload multiple documents from other storage devices in to the insurance management system, such as from a local computer or storage device, mobile device, network hard drive or other location Such may include uploading electronic documents to a central document repository stored on a nontransitory computer- or processor-readable medium 142 (FIG. 1), to allow access by at least one other party (e.g., agent, broker). Selection of a user selectable action (not illustrated) in an action pull-down menu 370 causes the system to perform an action on, or with respect to, all electronic documents identified by selection of the corresponding checkboxes 366. For example, an electronic document may be updated, marked with a status (e.g., completed, in progress, sent, revised, verified).

The messages subpanel 354 includes a content window 372. The content window 372 presents a set of electronic mail messages 374 (only one shown). Selection of a corresponding expand/collapse icon (i.e., [symbol] , ▾) toggles between presenting and hiding the content of the respective electronic mail message 374. A from field 376a indicates an identity of a sender of the particular electronic mail message. A title field 376b indicates a title of the electronic mail message or name of a project to which the electronic mail message is related. A date posted field 376c indicates a date that the electronic mail message was sent or otherwise posted. The fields 376a-376c are collectively referenced as 376.

A filter pull-down menu 378 allows filtering of electronic messages. Selection of a user selectable new message icon 380 opens a window that allows composition of a new electronic mail message, including entry of content, specification of intended recipient, title, and/or attachment of electronic documents or hyperlinks to electronic documents.

The drag and drop area 356 allows electronic or digital documents or files to be easily and seamlessly incorporated into the system and sent or shared with others (e.g., shared with underwriters by agents or brokers). Thus, documents from external sources may be incorporated, for instance, documents residing on an end user's desktop, hard drive, USB stick, received in via electronic mail outside the system, downloaded from a Website or other source.

The use of the active engagements panel 310 allows the end user (e.g., agent, broker) to easily create electronic mail messages and related electronic documents and transmit such to underwriters in an organized fashion, for example, selecting projects in the active engagements panel 310 and viewing, creating or attaching related electronic documents in the documents subpanel 352 and related messages in the messages subpanel 354 all on one screen or in one overall window.

The content of the various subpanels and fields within subpanels varies based on the identity of the logged in end user. Thus, one end user may have a first set of contacts at a first insurer, while a second end user may have a different set of contacts at the first insurer. The first end user may have a first set of insurers with which they have an existing relationship while a second end user may have a second different set of insurers with which they have an existing relationship. The sets may overlap in all, in part, or not at all.

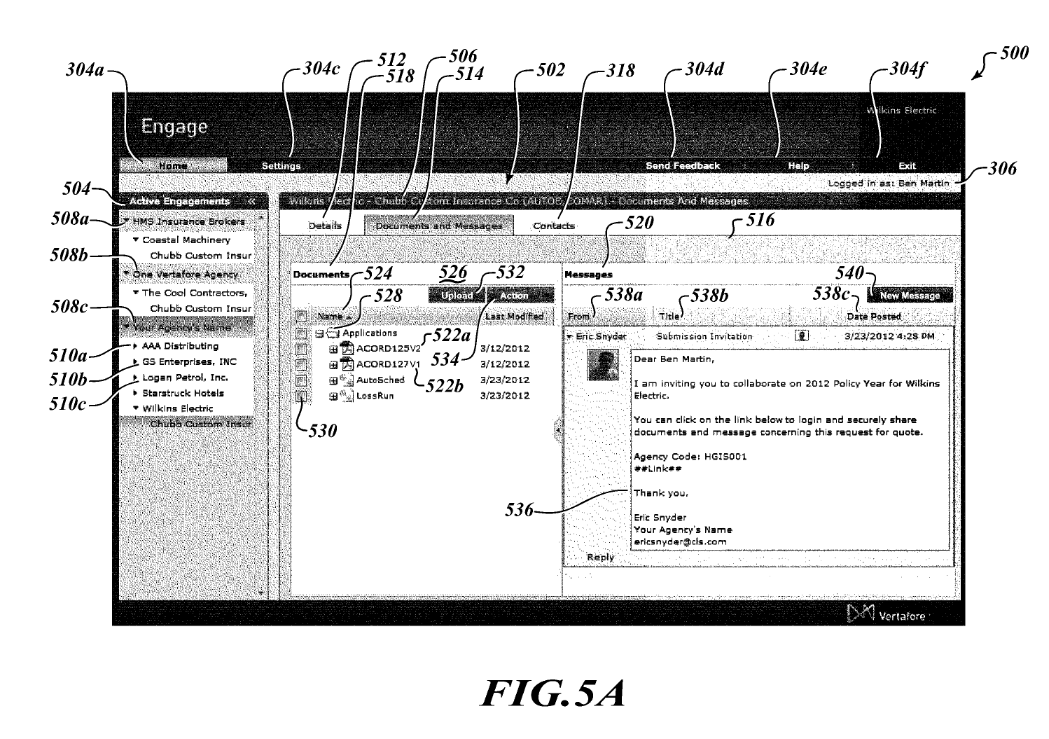

FIG. 5A shows a third portion 500 of a user interface as used by a first underwriter of a first insurer, according to one illustrated embodiment.

The third portion 500 of the user interface may be presented as a window or screen with a number of user interface components, for instance, menus, panels, dialog boxes, radio buttons, expansion controls and plus/minus icons (i.e., icons the selection of which cause a hierarchical list to expand and contract). The terms window and screen are used interchangeably herein to refer to a portion of a user interface (e.g., graphical user interface or GUI), which is displayed on a display or monitor and which provides information (i.e., output) to a user and which may allow the user to provide instructions, commands or information (i.e., input) to a processor-based device or an application executing on a processor-based device.

Some of the user interface components of the third portion 500 of the user interface illustrated in FIG. 5A are identical or similar to user interface components of the first portion 300 of the user interface illustrated in FIGS. 3-4. The identical or similar components are identified with the same reference numbers in FIG. 5A as were employed in FIGS. 3-4. Description of identical or similar components will not be repeated, in the interest of brevity. Only significantly different components are called out with separate reference numbers and discussed below.

The third portion 500 includes the main menu 302 with many of the same user selectable icons or tabs 304 and user field 306 of the first portion 300, omitting the client engagement user selectable icon or tab 304b from the main menu 302. The user may choose any of the user selectable icon or tabs 304 by selecting the desired user selectable icon or tab with a pointer, for example, by manipulating a mouse, trackpad or trackball, touching a touch sensitive display, or tabbing using an appropriate tab key on a keyboard or keypad, or by speaking commands.

Selection of the settings icon or tab 304c causes presentation of a settings panel (not illustrated for underwriter). The settings panel allows the insurer's underwriter to initially set various settings or modify existing settings. The settings panel presented to the insurer's underwriter may be similar, or even identical, to the settings panel 308 (FIG. 3) presented to the agents or brokers, for instance, composed of a number of subpanels.

Selection of the home icon or tab 304a causes presentation of a home panel 502. The home panel 502 may be composed of a number of subpanels, for example, an active engagement subpanel 504 and a work subpanel 506.

The active engagements subpanel 504 provides a set of user selectable agency or brokerage icons 508a-508c (three shown, collectively 508) which identify and correspond to a number of agencies or brokerages with which the insurer's underwriter has defined logical relationships. The set of agency or brokerage icons 508 displayed to any given end user (e.g., underwriter), may be customized for the particular end user or for the particular insurer for which the underwriter works. For example, the agency or brokerage icons 508 may identify each agency or brokerage which has an existing relationship with either the insurer or the particular underwriter.

Selection of a user selectable expand/collapse icon (i.e., [symbol] , ▾) toggles between presenting and hiding sets of user selectable consumer or insured icons 510a-510c (only three called out, collectively 510). The user selectable consumer or insured icons 510a-510c specify particular consumers, policyholders or insureds which have existing insurance policies or for which insurance policies are being developed, grouped by the agency or brokerage through which the consumers, policyholders or insureds are working. Selection of a user selectable hide/show icon (i.e., <<) toggles between presenting and hiding the active engagement subpanel 504. The active engagement subpanel 504 may additionally appear or be presented in other panels such as panels presented under the settings icon or tab 304c. Selection of one of the user selectable consumer or insured icons 510 updates the content of the work subpanel 506, which displays consumer or project specific information, as discussed below.

The work subpanel 506 includes a number of tabs. In particular, the work subpanel 506 may include a details tab 512, document and message tab 514, and a contacts tab 318.

User selection of the details tab 512 brings up a details subpanel, (not shown) which provides detail information about the consumer, project and/or agent/broker. Such may include a consumer or insured name, address, principal contact telephone and facsimile numbers, lines of business for which insurance is sought, policy limits desired, deductibles to be applied, geographic information, past claims activity, and other information relevant to issuing policies or evaluating requests for policies.

User selection of the contacts tab 318 brings up a contacts subpanel (not shown for underwriter), which includes a list portion and a details portion specifying contact information similar to that illustrated in FIGS. 3-5.

User selection of the documents and messages 514 brings up a documents and messages panel 516. The documents and messages panel 516 may include a number of subpanels, for example, a document subpanel 518 and a messages subpanel 520.

The document subpanel 518 provides a set of user selectable document icons 522a, 522b (only two called out, collectively 522). The user selectable document icons 522 correspond to each of a number of electronic documents which are associated with the specified consumer, policyholder or project. The electronic documents may include one or more versions of a single electronic document. For example, a list or set of document may include an initial or original electronic document, 358b, as well as a newer changed or revised electronic document 522a, which includes changes or revisions to the initial or original electronic document 522b. The most recent version may be identified, for example, visually. For instance, the most recent version may appear at a top of the list, or at a highest level of a nested hierarchy of various versions of the electronic document. Other visual effects such as color, highlighting, marqueeing and/or flashing may be employed. Visual effects may be displayed on the icon corresponding to the most recent version of the electronic document or spatially proximate thereto.

The electronic documents may take a variety of forms useful in assessing, supporting or otherwise documenting the evaluation, consideration, or assessment of whether to bind a policy, and the specific particulars of such policy such as limits, deductibles, exclusions, endorsements, etc. The document subpanel 518 may include a name field 524 and a date field 526. The name field 524 may indicate a name of the specific document, while the date field 526 may indicate a date on which the specific document was last modified, and/or a date on which the specific document was created.

The user selectable document icons 522 may be arranged in a hierarchical fashion, such as in one or more folders 528 (one called out) of a nested folder structure. Selection of a user selectable expand/collapse icon (i.e., +, −) toggles between expanding and collapsing the contents of folders 528.

Selection of an electronic document, for example, by double clicking with a cursor positioned on a corresponding electronic document icon, may cause the specific electronic documents to be opened in an appropriate viewer (e.g., word processing program, spreadsheet program, image viewer program).

Selection of a corresponding checkbox 530 (only one called out) allows a user to select one or more documents for the insurance managements system to perform one or more actions on the selected documents or folders including, but not limited to, adding a new version, copying, or deleting the selected document. Additional actions which may not be related to a corresponding checkbox 530 may include, but are not limited to, the insurance management system organizing or enabling organization of a folder structure in which to organize documents (e.g., by adding a new folder or folder structure in which to organize documents or removing folders). Clicking the Upload icon 532 allows a user to choose and upload multiple documents from other storage devices in to the insurance management system, such as from a local computer or storage device, mobile device, network hard drive or other location. Such may include uploading electronic documents to a central document repository stored on a nontransitory computer- or processor-readable media 142 (FIG. 1), to allow access by at least one other party (e.g., agent, broker). Selection of a user selectable action (not illustrated) in an action pull-down menu 534 causes the system to perform an action on, or with respect to, all electronic documents identified by selection of the corresponding checkboxes 530. For example, an electronic document may be updated, marked with a status (e.g., completed, in progress, sent, revised, verified).

The messages subpanel 520 includes a content window 536 and a number of fields, collectively 538. The content window 536 presents the content (e.g., text) of an electronic mail message. The fields 538 may include a from field 538a, which indicates an identity of a sender of the particular electronic mail message. A title field 538b indicates a title of the electronic mail message or name of a project to which the electronic mail message is related. A date posted field 538c indicates a date that the electronic mail message was sent or otherwise posted.

Selection of a user selectable new message icon 540 opens a window that allows composition of a new electronic mail message, including entry of content, specification of intended recipient, title, and/or attachment of electronic documents or hyperlinks to electronic documents.

The use of the active engagements panel 504 allows the end user (e.g., underwriter) to easily access all electronic mail messages and related electronic documents in an organized fashion, for example, selecting projects in the active engagements panel 504, viewing related electronic documents in the documents subpanel 518 and related messages in the messages subpanel 520 all on one screen or in one overall window.

FIG. 5B is a screen print of a fourth portion of a user interface particularly illustrating pre-selected previous submissions for which to provide an update including a new version of a document, as used by the first agent or broker of the first agency or brokerage, according to one illustrated embodiment.

The fourth portion 542 of the user interface may be presented as a window or screen with a number of user interface components, for instance, menus, panels, dialog boxes, radio buttons, expansion controls and plus/minus icons (i.e., icons the selection of which cause a hierarchical list to expand and contract).

Some of the user interface components of the fourth portion 542 of the user interface illustrated in FIG. 5B are identical or similar to user interface components of the portions of the user interfaces illustrated in FIGS. 3-5A. The identical or similar components are identified with the same reference numbers in FIG. 5B as were employed in FIGS. 3-5A. Description of identical or similar components will not be repeated, in the interest of brevity. Only significantly different components are called out with separate reference numbers and discussed below.

The fourth portion 542 includes the main menu 302 with many of the same user selectable icons or tabs 304 and user field 306 of the first portion 300. The user may choose any of the user selectable icon or tabs 304 by selecting the desired user selectable icon or tab with a pointer, for example, by manipulating a mouse, trackpad or trackball, touching a touch sensitive display, or tabbing using an appropriate tab key on a keyboard or keypad, or by speaking commands.

User selection of the client engagements user selectable icon or tab 304b and then the document and messages tab 514 brings up the documents and messages panel 350. As shown in FIGS. 4 and 5A, the documents and messages panel 350 may include a number of subpanels, for example, a document subpanel 352 and a messages subpanel 354, as well as a drag and drop area 356, the use of which may cause the document propagation selection subpanel 544 as shown in FIG. 5B to be presented.

For example, as shown in FIG. 4, document subpanel 352 provides a set of user selectable document icons 358a, 358b (only two called out, collectively 358). The user selectable document icons 358 correspond to each of a number of electronic documents which are associated with the specified consumer, policyholder or project. The electronic documents may include one or more versions of a single electronic document. For example, a list or set of documents may include an initial or original electronic document, 358b, as well as a newer changed or revised electronic document 358a, which includes changes or revisions to the initial or original electronic document 358b. The most recent version may be identified, for example, visually. Selection of a corresponding checkbox 366 (only one called out) as shown in FIG. 4, allows one or more corresponding electronic documents to be selected for either uploading or for some other action. For example, selection of a user selectable upload icon 368 shown FIG. 4 may bring up the document propagation selection subpanel 544 as shown in FIG. 5B. Alternatively or additionally, selection of a user selectable action (not illustrated) in the action pull-down menu 370 of FIG. 4 may cause the system to perform an action on, or with respect to, all electronic documents identified by selection of the corresponding checkboxes 366 shown in FIG. 4. In some embodiments, the list of actions may include an action that brings up the document propagation selection subpanel 544 as shown in FIG. 5B.

The document propagation selection subpanel 544 presents a list of previous submissions 546 to insurers. Each submission in the list of previous submissions 546 may have a corresponding checkbox 548 (only one called out) to allow one or more of the corresponding previous submissions to be selected. User selection of the upload icon 549 causes the selected submissions in the list of submissions 546 to be updated or otherwise associated with the with the electronic documents (or particular version of electronic document) previously selected in the document subpanel 352 shown in FIG. 4. Updating the selected previous submission with the with the selected electronic documents may include sending to, sharing with or otherwise propagating the electronic document to a particular potential recipient associated with the selected previous submission (e.g., by email, allowing access, sending notification, and/or other electronic transfer of the document or updated portion of the document to the associated recipient or recipients).

For example, if an agent may create a new version of a document that was previously submitted as part of a submission to an insurer. The agent may select the updated version of the document subpanel 352 shown in FIG. 4 and once the agent selects the upload icon 368 in FIG. 4 the list of previous submissions 546 will be presented such that the agent may select which of the previous submissions to update with the new version of the document. Then the insurance management system will automatically update each selected previous submission with the new version of the document as a result of the agent selecting the upload icon 549 shown in FIG. 5B.

Particular previous submissions may be presented in the list of submissions 546, may be pre-selected (e.g., as shown by the check in checkbox 548) within the list of submissions 546, and/or may be prevented from appearing in the list of submissions 546 based on a variety of factors including, but not limited to: status of the previous submission; preferences stored by the insurance management system of an associated insurer, agent and/or other system user; permission levels of an associated insurer, agent and/or other system user; access type of an associated insurer, agent and/or other system user; type of system user; whether the submission has a version of the selected document associated with the submission; a version of the selected document associated with the submission; a type of insurer; etc. For example, each previous submission that already has a version of the selected document associated with the submission may be pre-selected in the list of submission 546 as these submissions would likely benefit from an updated version of that document. Also, submissions that are presented in the list of submissions 546, but which are not pre-selected may be selected by the user, as shown by the selection prompt 550.

Selection of the cancel icon 552, causes the propagation of the currently selected documents to the selected previous submissions to be canceled and in some embodiments, may cause the current selections in the list of submissions 546 to be cleared and/or the document propagation selection subpanel 544 to revert back to the documents subpanel 352 as shown in FIG. 4 or a different panel.

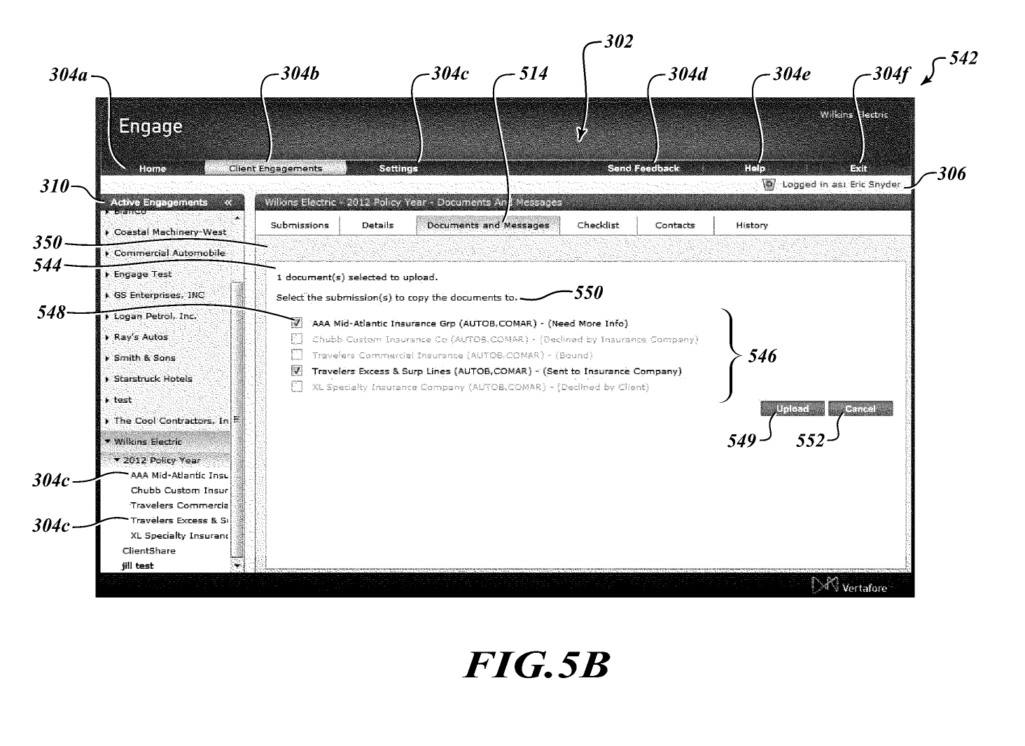

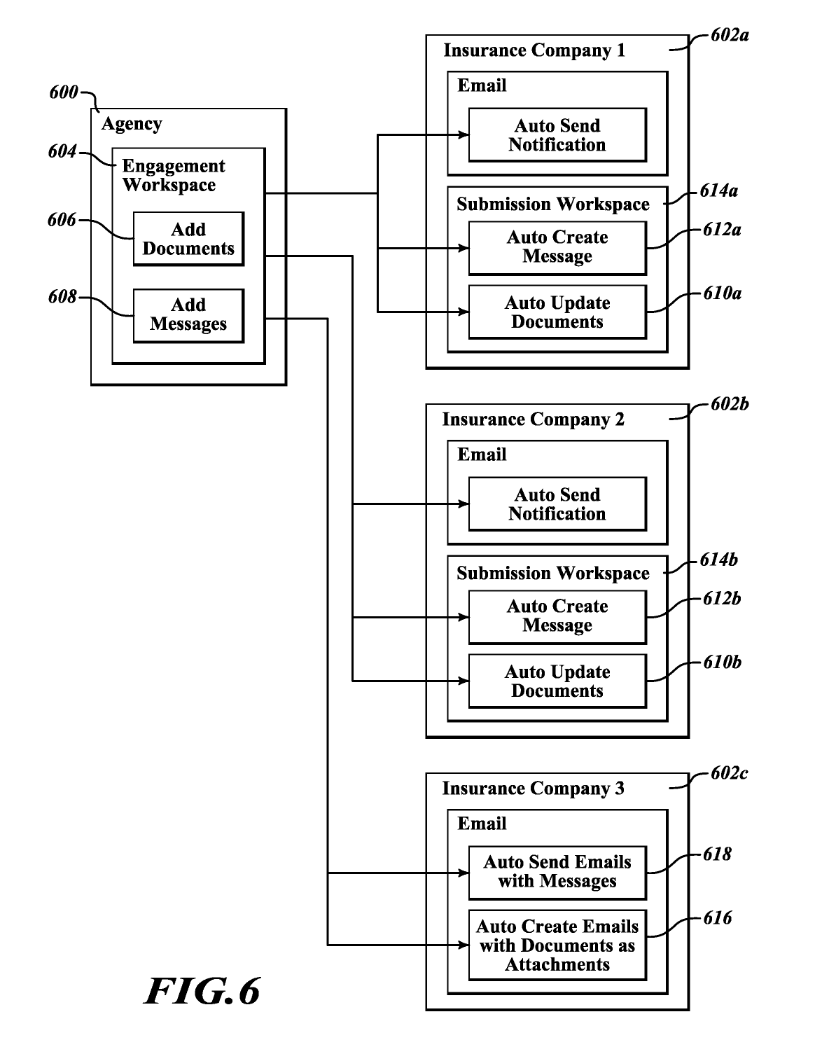

FIG. 6 shows an agent or broker or an agency or brokerage 600 using a workspace to electronically communicate with an insurance management system to electronically communicate with a number of underwriters of a number of insurers 602a-602c (collectively 602), according to one illustrated embodiment.

An agent or broker at an agency or brokerage 600 may operate in a user interface denominated in FIG. 6 as an Engagement workspace 604. Such may take the form of a user interface produced by one or more software applications, which may be executed by an insurance management system server computer system and supplied to devices operated by the agents or brokers, for instance, as WebPages and/or Web services. Alternatively, one or more applications may execute on end user processor-based devices operated by the agents or brokers.

The engagement workspace 604 includes a section, panel or other delimitated area 606 to add electronic documents and a section, panel or other delimitated area 608 to add (e.g., create) messages. Electronic documents may be added by dragging and dropping a user selectable icon that represents the electronic document to the section, panel or other delimitated area 606. Electronic messages may be posted and displayed in a messages panel of the engagement workspace 604 by dragging and dropping a user selectable icon that represents the electronic document to the section, panel or other delimitated area 608, or by selecting a send icon or similar icon.

In response to the adding of electronic documents and/or electronic messages, electronic documents may be automatically updated 610a, 610b and messages 612a, 612b automatically created in a respective submission workspace 614a, 614b (collectively 614) for each of a number of underwriters associated with respective insurers 602a, 602b, who use the submission workspaces 614. Such may be implemented by storing the electronic documents and electronic messages centrally, for example, by an insurance management system server computer system. Such may be implemented by selectively providing access by the various end users to the electronic documents and/or electronic messages, by an insurance management system server computer system. Selective access may, for example, be based on: 1) identification of the end user, 2) end user interest therein, and/or 3) end user status with respect to a particular prospective policy proposal.

Additionally, an electronic mail message 616a, 616b may be automatically sent to network addresses logically associated with one or more of the underwriters of one or more insurers 602a, 602b indicating that new or revised or changed electronic documents are available and/or new electronic messages are available in the respective submission workspaces 614. The automatic generation and transmission of the electronic mail may be performed by an insurance management system server computer system or alternatively by a processor-based device operated by the agent or broker or by the agency or brokerage.

Where the underwriter of a particular insurer 602c is not using a submission workspace, adding of electronic documents and/or electronic messages may cause automatic transmission of an electronic mail message 616 with the electronic documents attached to be sent to a network address logically associated with the underwriter. Such may additionally, or alternatively, cause automatic transmission of an electronic mail message 618 with the new messages attached to be sent to a network address logically associated with the underwriter. The automatic generation and transmission of the electronic mail may be performed by an insurance management system server computer system or alternatively by a processor-based device operated by the agent or broker or by the agency or brokerage.

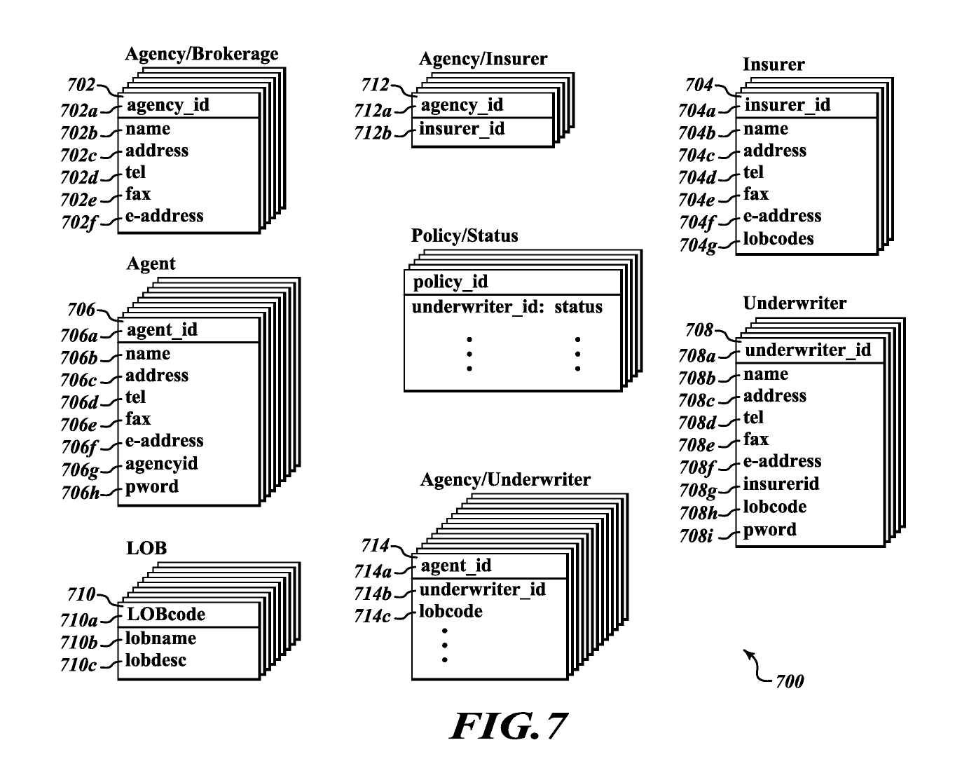

FIG. 7 shows a database schema 700 according to one illustrated embodiment. The illustrated database schema 700 may be suitable for use in an insurance management system to automate and/or manage communications between processor-based devices operated by agents or brokers of various agencies or brokerages and processor-based devices operated by underwriters of an insurer. Other database schemas may be suitable. The database schema 700 may be implemented in one or more computer- or processor-readable storage media, by operation of one or more processors that execute suitable instructions. The database schema 700 may include a number of data structures to store various pieces of information used in automating and managing the communications. The data structures may include a record, table or other data structure which includes information or data.

The database schema 700 may include a number of agency/brokerage records 702 that store information related to agencies. The agency/brokerage records 702 may include a number of fields, including an agency/brokerage_id field 702a, which is a key field on which a search may be performed. The agency/brokerage records 702 may include a name field 702b to store a name of the agency/brokerage, an address field 702c to store a physical or mailing address of the agency/brokerage, a tel field 702d to store a telephone number, a fax field 702e to store a facsimile number for the agency/brokerage, and an e-address field 702f to store one or more electronic mail addresses for the agency/brokerage.

The database schema 700 may include a number of insurer records 704 that store information related to agencies. The insurer records 704 may include a number of fields, including an insurer_id field 704a, which is a key field on which a search may be performed. The insurer records 704 may include a name field 704b to store a name of the insurer, an address field 704c to store a physical or mailing address of the insurer, a tel field 704d to store a telephone number, a fax field 704e to store a facsimile number for the insurer, and an e-address field 704f to store one or more electronic mail addresses for the insurer. The insurer records 704 may also include an LOB_Codes field 704g that stores codes of one or more lines of business handled by the insurer.

The database schema 700 may include a number of agent/broker records 706 that store information related to agencies. The agent/broker records 706 may include a number of fields, including an agent/broker_id field 706a, which is a key field on which a search may be performed. The agent/broker records 706 may include a name field 706b to store a name of the agent/broker, an address field 706c to store a physical or mailing address of the agent/broker, a tel field 706d to store a telephone number, a fax field 706e to store a facsimile number for the agent/broker, and an e-address field 706f to store one or more electronic mail addresses for the agent/broker. The agent/broker records 706 may also include an agency_id field 706g that stores an identifier that uniquely identifies an agency or brokerage for which the agent/broker works. The identifier in the agency_id field 706g allows an agent or broker to be logically associated with an agency record 702. The agent/broker records 706 may also include a pword field 706g that stores a password, which allows attempts to access the system to be verified or authenticated. The password may be selected by the particular agent or broker.

The database schema 700 may include a number of underwriter records 708 that store information related to agencies. The underwriter records 708 may include a number of fields, including an underwriter id field 708a, which is a key field on which a search may be performed. The underwriter records 708 may include a name field 708b to store a name of the underwriter, an address field 708c to store a physical or mailing address of the underwriter, a tel field 708d to store a telephone number and fax field 708e to store a facsimile number for the underwriter, and an e-address field 708f to store one or more electronic mail addresses for the underwriter. The underwriter records 708 may also include an insurer_id field 708g that stores an identifier that uniquely identifies an insurer for which the underwriter works. The identifier in the insurer_id field 708g allows an underwriter to be logically associated with an insurer record 704. The insurer record 704 may also include an LOB_Codes field 708h that stores codes of one or more lines of business handled by the underwriter. The underwriter records 708 may also include a pword field 708i that stores a password, which allows attempts to access the system to be verified or authenticated. The password may be selected by the particular agent or broker.

The database schema 700 may include a number of lines of business (LOB) records 710 that store information related to lines of business. The LOB records 710 may include a number of fields, including an LOB-Code field 710a, which is a key field on which a search may be performed. The LOB records 710 may include an LOB_name field 710b to store a name of a line of business and, optionally, an LOB_desc field 710c to store a text description of the particular line of business.

The database schema 700 may include a number of agency/insurer records or table 712 that store information that relates agencies and/or brokerages to insurers. The agency/insurer records or table 712 may include a number of fields. For example, agency/insurer records or table 712 may include an agency/broker_id field 712a, which stores agency/broker identifiers which uniquely identify an agency or broker and which is a key field on which a search may be performed. The agency or broker identifiers allow logical relationships to be made to the agency/brokerage records 702. Also, for example, agency/insurer records or table 712 may include an insurer_id field 712b, which stores insurer identifiers which uniquely identify an insurer and which may be a key field on which a search may be performed. The insurer identifiers allow logical relationships to be made to the insurer records 704.

The database schema 700 may include a number of agent/underwriter records or table 714 that store information that relates agents and/or brokers to underwriters of insurers. The agent/underwriter records or table 714 may include a number of fields. For example, agent/underwriter records or table 714 may include an agent/broker_id field 714a, which stores agency/broker identifiers which uniquely identify an agent or broker and which is a key field on which a search may be performed. The agency/broker identifiers may, for example, take the form of electronic mail addresses via which the respective agents or brokers receive electronic correspondence. Alternatively, the agency/broker identifiers may take the form of a numeric or alphanumeric identifier. The agent or broker identifiers allow logical relationships to be made to the agent/broker records 706. Also, for example, agent/underwriter records or table 714 may include a rep_id field 714b, which stores underwriter identifiers which uniquely identify an underwriter of an insurer and which optionally may be a key field on which a search may be performed. The underwriter identifiers allow logical relationships to be made to the underwriter records 708. The underwriter identifiers may, for example, take the form of electronic mail addresses via which the respective underwriters receive electronic correspondence. Alternatively, the underwriter identifiers may take the form of a numeric or alphanumeric identifier. The agent/underwriter records or table 714 may further include an LOB_code field 714c. The LOB-code field 714c may store one or more LOB-codes which may specify specific lines of business that the agent or broker uses the respective insurer underwriter to handle. This may allow electronic correspondence, including sharing of electronic documents, to be targeted to specific underwriters based on the lines of business to which the correspondence and/or electronic documents relate.

The database schema 700 may include a number of policy/status records or tables 714 that store information that relates insurance policies with underwriters and status. The policy/status records or tables 714 may include a number of fields. For example, policy/status records or tables 714 may include a policy_id field 714a, which stores a policy identifier which uniquely identifies a policy which is being worked on by an agent or broker and/or underwriter, and which is a key field on which a search may be performed. The policy/status records or tables 714 may include one or more underwriter id fields which store underwriter identifiers that uniquely identify underwriters to which the policy has been submitted for consideration of or evaluation for underwriting. The policy/status records or tables 714 may include one or more status fields which store status identifiers that indicate a current status of the policy with respect to a respective one of the underwriters. The status (e.g., in progress, need more, quoted, bound or declined) of each policy may vary over time for each of the underwriters. For example, one underwriter may quickly decline, for instance due to a line of business or some unacceptable terms and conditions. Other underwriters may request further information, or may quote an amount for the policy, or accept or be bound by the policy. Tracking the status of each potential policy with respect to each underwriter allows customization of a user interface which is presented to the respective underwriter, such that only pertinent information is provided.

The database schema 700 is illustrative. The database schema 700 may employ additional records or tables and/or may omit some records or tables. The illustrated records or tables may include additional fields, omit some of the illustrated fields, and/or may be arranged in forms other than illustrated.

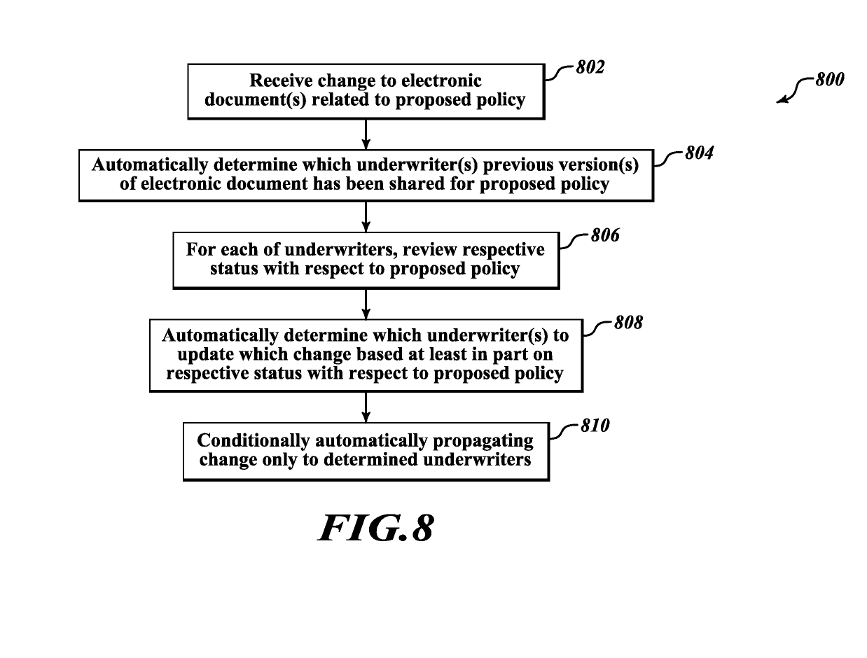

FIG. 8 shows a high level method 800 of operation of an insurance management system to automate and/or manage electronic documents between one or more agents or brokers and one or more underwriters of a number of insurers, according to one illustrated embodiment.

An insurance management system may automatically select which electronic communications and/or electronic documents to share or propagate to which potential recipients (e.g., an underwriter of an insurer). The insurance management system may do so based on whether or not a previous electronic correspondence or version of the electronic document was sent, shared or otherwise propagated with a particular potential recipient. Such may additionally, or alternatively, be based on whether or not a particular potential recipient has logically expressed an interest in such, for example by expressing an interest in quoting a policy as indicated by a current submission status of the potential recipient with receipt to a particular policy or a line or business. The insurance management system may allow an end user sender (e.g., agent, broker) and/or potential recipient (e.g., underwriter, insurer) to override such selection. For example, the insurance management system may allow the sender to send or propagate to additional potential recipients, for instance those who have not received previous electronic correspondence or versions or an electronic document. Also for example, the insurance management system may allow the sender to prevent sending or propagating electronic correspondence or electronic documents to selected potential recipients even though those potential recipients had received previous electronic correspondence and/or electronic documents and have a status that would otherwise cause them to continue to receive such.

Upon end user confirmation, the insurance management system may propagate new electronic documents or new versions of electronic documents to potential recipients. Such may include propagating electronic documents or versions thereof to a respective workspace (e.g., underwriter submission workspace) for each of the intended recipients. The insurance management system may automatically notify the intended recipient of the availability of the new electronic document or new version in the workspace, for example by automatically sending an electronic mail message to a network address logically associated with the intended recipient.

Additionally, or alternatively, the insurance management system may optionally propagate the new electronic documents or versions to the recipients own computing system or intranet. For example, the new electronic documents or versions may be automatically pushed from the workspace to an insurer's back office system based on a set of defined settings. Such may be accomplished via electronic mail with corresponding electronic documents attached, or via other techniques for instance using Web services.

At 802, an insurance management system server computer system detects a new electronic document or change(s) to electronic document(s) related to proposed policy. For example, the insurance management system server computer system may receive the change or the changed electronic document. Such may, for instance, occur in response to a movement of a user interface element that represents a changed electronic document or changed version of the electronic document to a defined area of a user interface for posting documents. For instance, an agent or broker may make a change to an electronic document, then move (e.g., select and drag with cursor) a user selectable icon representing the changed document to a delimitated area in the user interface. The electronic document may have been created and changed or modified using any of a large variety of software applications programs, for instance, word processing programs, scanning programs, spreadsheet programs, modeling programs. The electronic documents may use generally available formats (e.g., Microsoft WORD® or EXCEL®), or may be a proprietary format (e.g., of the agency or brokerage).

At 804, the insurance management system server computer system automatically determines which of a plurality of underwriters with which a previous version of the changed electronic document has been shared for the proposed policy. For example, the insurance management system server computer system may check a database that tracks the identity of all entities that received or were otherwise granted access to an original version of an electronic document, or subsequent versions thereof. Such may reflect a distribution set or list for the document and/or a policy solicitation or request for proposal.

For instance, an agent or broker may try to secure one or more policies for a particular consumer, policyholder or insured. The agent or broker may identify a set of underwriters to underwrite the particular policy. The set of underwriters may be identified or selected based on a variety of criteria, for example, a pre-existing or defined relationship between the underwriter and the agent or broker and/or an ability or experience level of the underwriter with a particular line of business to which the policy relates. The insurance management system server computer system may store this information as logical relationships, automating the process. This allows electronic communications and electronic documents to be automatically multi-cast to a plurality of appropriate underwriters. This defines an initial distribution or access list, which may be reduced or narrowed as underwriters accept or decline the opportunity to underwrite the specific policy, as discussed below.

At 806, for each of underwriters, the insurance management system server computer system reviews a respective status with respect to proposed policy. For example, a processor of the insurance management system server computer system may query a database, table or other data structure stored in a nontransitory computer-readable medium. The status may reflect an action taken by the respective underwriter with respect to the particular policy. For instance, the underwriter may select a corresponding user selectable icon to decline the policy or to accept or otherwise agree (i.e., be bound) to underwrite the policy based on currently agreed to terms and conditions. Such are illustrative of a number of actions or status which may be logically associated with a policy. Others may include: in progress, need more information, and quoted.

At 808, the insurance management system server computer system automatically determines which of the underwriters to update which change based at least in part on respective status with respect to proposed policy. For example, the insurance management system server computer system may determine that underwriters which have a status of declined will not receive changes since those underwriters have already indicated their desire to opt out of the particular policy. Also, for example, the insurance management system server computer system may determine that underwriters which have a status of bound will not receive changes since those underwriters have already indicated their desire to be bound by the current terms and conditions of the particular policy.

At 810, the insurance management system server computer system conditionally automatically propagates change only to determined underwriters. Thus, an underwriter of an insurer may advantageously see updated, changed or versioned electronic documents for only those policies which the underwriter is still working on underwriting. Propagation may take a variety of forms, for instance, pushing of changed electronic documents or changes, electronic notification of the availability of changed electronic documents, updating of user interface(s) to display user selectable icons corresponding to changed electronic documents or changes, and/or versioning of electronic documents. Electronic documents from any number of agents or brokers of any number of agencies or brokerages may be presented to the underwriter in a single document pane or panel of a user interface, and may be grouped by the particular consumer, policyholder or insured and/or by the particular policy (e.g., type of policy, for instance, as general commercial).

The method 800 may terminate until called again. Alternatively, the method 800 may run concurrently with other methods or processes, for example, as one of multiple threads on a multi-threaded processor system.

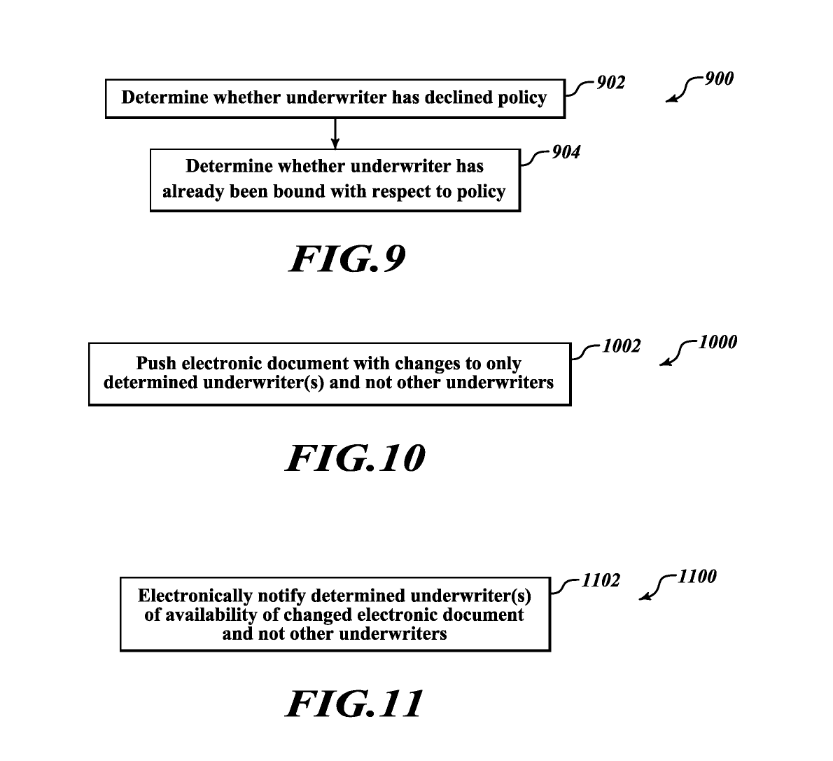

FIG. 9 shows a low level method of operation 900 of an insurance management system to automate and/or manage electronic documents between one or more agents or brokers and one or more underwriters of a number of insurers, according to one illustrated embodiment. The method 900 may be used in addition to, or as part of, the method 800 (FIG. 8).

At 902, an insurance management system server computer system determines whether an underwriter has declined a policy. The insurance management system server computer system may, for example, check one or more records, tables or other data structures of a database. The database may track a status of the underwriter with respect to each policy for which underwriting has been electronically solicited by an agent or broker.

At 904, the insurance management system server computer system determines whether an underwriter has already been bound with respect to a policy. The insurance management system server computer system may, for example, check one or more records, tables or other data structures of a database. The database may track a status of the underwriter with respect to each policy for which underwriting has been electronically solicited by an agent or broker.

The method 900 may terminate until called again. Alternatively, the method 900 may run concurrently with other methods or processes, for example, as one of multiple threads on a multi-threaded processor system.

FIG. 10 shows a low level method of operation 1000 of an insurance management system to automate and/or manage electronic documents between one or more agents or brokers and one or more underwriters of a number of insurers, according to one illustrated embodiment. The method 1000 may be used in addition to, or as part of, the method 800 (FIG. 8).

At 1002, an insurance management system server computer system pushes an electronic document with changes to only underwriter(s) which are determined to receive the changes, and not other ones of the underwriters.

As explained above, an initial set of underwriters may be initially identified or selected to receive correspondence and/or electronic documents related to a policy to be underwritten. Some of those underwriters may opt to decline to underwrite the policy, so have no need, nor desire, to see any further correspondence or electronic documents related to the policy. Likewise, some of the underwriters may at some point provide an indication of an acceptance or agreement to underwrite the policy if issued, and thus be bound. These underwriters have no need to see changes to electronic documents, since these underwriters would not be required to, and may not be open to, accept any changes in the terms and conditions already agreed to or accepted. Thus, changes are pushed to a subset of the initial set of underwriters, based on a respective status of the underwriters with respect to the particular policy. Pushing may include electronic transmittal of the changed documents or changes to the subset of underwriters, for instance, by transmitting the changed documents or changes to network addresses of processor-based devices operated by the underwriters and logically associated therewith, for instance, in a routing table.

The method 1000 may terminate until called again. Alternatively, the method 1000 may run concurrently with other methods or processes, for example, as one of multiple threads on a multi-threaded processor system.

FIG. 11 shows a low level method of operation 1100 of an insurance management system to automate and/or manage electronic documents between one or more agents or brokers and one or more underwriters of a number of insurers, according to one illustrated embodiment. The method 1100 may be used in addition to, or as part of, the method 800 (FIG. 8).

At 1102, an insurance management system server computer system electronically notifies determined underwriter(s) of availability of a changed electronic document and not other underwriters.

As explained above, underwriters may be initially identified or selected to receive correspondence and/or electronic documents related to a policy to be underwritten. Some underwriters of an initial set of underwriters may opt to decline to underwrite a policy or may accept or agree to underwrite the policy if issued (i.e., bound), so have no need or desire to see proposed changes to electronic documents related to the policy. Electronically notifying may include sending electronic messages such as electronic mail (i.e., email), text messages, short message service (SMS) messages, facsimiles, or other forms of electronic correspondence which indicates that changes have been made to certain documents. For instance, such may include notification in a user interface employed by the underwriter. The notification may, for instance, take the form of one or more visual indicators. The visual indicator(s) may be visually or proximally associated with the document or changed document. For instance, visual indicators may be displayed on or next to an icon that is associated with the electronic document or changed electronic document. Thus, an icon (e.g., graphic, text), for instance, a user selectable icon, may have a flag, color, or visual emphasis (e.g., highlighting, flashing, marqueeing) displayed to indicate that the electronic document has changed. Selection of the user selectable icon may open the changed electronic document. The changes to the electronic document may be visually apparent, for instance, via redlining techniques, such as strikethrough of deleted text and underlining of added text.

The method 1100 may terminate until called again. Alternatively, the method 1100 may run concurrently with other methods or processes, for example, as one of multiple threads on a multi-threaded processor system.

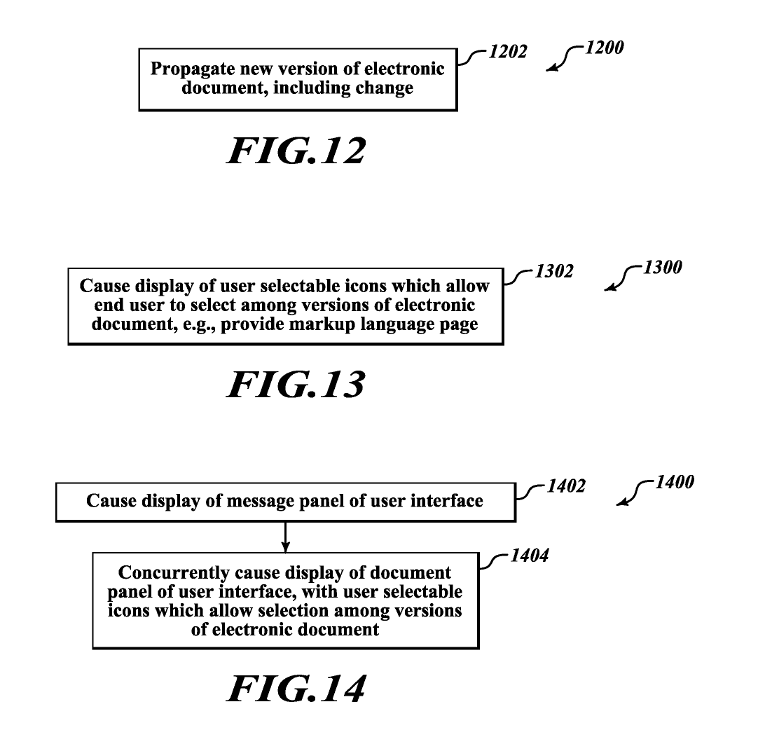

FIG. 12 shows a low level method of operation 1200 of an insurance management system to automate and/or manage electronic documents between one or more agents or brokers and one or more underwriters of a number of insurers, according to one illustrated embodiment. The method 1200 may be used in addition to, or as part of, the method 800 (FIG. 8).

At 1202, an insurance management system server computer system propagates new version of an electronic document, including changes. The insurance management system server computer system may automatically implement versioning, saving new versions of an electronic document as the electronic document goes through iterations and propagating those versions. Such may include providing one or more versions of the electronic document or access thereto, to a subset of the initial set of underwriters. The propagation may include updating a user interface to display the new version along with previous versions. Such may include ordering a list or set of versions, from most recent to oldest. The updated user interface may be presented to agents and brokers, as well as the subset of underwriters.

The method 1200 may terminate until called again. Alternatively, the method 1200 may run concurrently with other methods or processes, for example, as one of multiple threads on a multi-threaded processor system.

FIG. 13 shows a low level method of operation 1300 of an insurance management system to automate and/or manage electronic documents between one or more agents or brokers and one or more underwriters of a number of insurers, according to one illustrated embodiment. The method 1300 may be used in addition to, or as part of, the method 800 (FIG. 8).

At 1302, an insurance management system server computer system causes display of user selectable icons which allow end users to select among versions of an electronic document. For example, insurance management system server computer system may implement a user interface for the underwriters, as well as a user interface for the agents or brokers. The insurance management system server computer system may implement the user interface(s) via a number of markup language pages and/or Web services. The markup language pages intended for the various underwriters may have a generally consistent format. The markup language pages intended for the various agents or brokers may have a generally consistent format. Thus, the underwriters may be presented with a first user interface, while the agents or brokers may be presented with a second user interface, different from the first user interface. The insurance management system server computer system may customize the content of the user interface(s) based on the particular end user. For example, a list of electronic documents, or versions of electronic documents, may be customized based on a current status of the particular end user with respect to one or more policies. The customization makes the user interface much more effective for a particular end user, eliminating needless clutter.

The method 1300 may terminate until called again. Alternatively, the method 1300 may run concurrently with other methods or processes, for example, as one of multiple threads on a multi-threaded processor system.

FIG. 14 shows a low level method of operation 1400 of an insurance management system to automate and/or manage electronic documents between one or more agents or brokers and one or more underwriters of a number of insurers, according to one illustrated embodiment. The method 1400 may be used in addition to, or as part of, the method 800 (FIG. 8).

At 1402, an insurance management system server computer system causes display of a message panel of user interface. The message panel may include a list or set of electronic messages directed to the particular end user (e.g., underwriter). The messages may be organized in a variety of fashions, for example, by the policy to which the message is concerned.

At 1404, the insurance management system server computer system concurrently causes display of a document panel of user interface. The document panel may include a list or set of icons (e.g., graphical, text) which represent various electronic documents. Such may optionally include versions of the electronic documents. A most recent version of an electronic document may be displayed in a conspicuous form, for example, at a top of a list or at a highest level in a nested list, or alternatively may be the only version of the electronic document displayed. The icons may be user selectable, allowing selection to open the electronic document. Selection may cause the electronic document to automatically open in an appropriate application or viewer. For example, selection may cause a native word processing or spreadsheet application to launch and open the document. Alternatively, selection may cause the document to be opened in a non-native application or viewer, such as one associated with the user interface. Such may allow the end user to conveniently review all electronic documents related to a particular policy, including a most recent version of an electronic document which has been changed one or more times.

The method 1400 may terminate until called again. Alternatively, the method 1400 may run concurrently with other methods or processes, for example, as one of multiple threads on a multi-threaded processor system.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification including, but not limited to: U.S. application Ser. No. ______ filed on Apr. 19, 2012 in the names of Eric William Snyder, Lloyd Sutton Hawes II and Hon Seng Long and entitled “APPARATUS, METHOD AND ARTICLE TO AUTOMATE AND MANAGE COMMUNICATIONS TO MULTIPLE ENTITIES IN A NETWORKED ENVIRONMENT” (Atty. Docket No. 930140.408) and U.S. application Ser. No. ______ filed on Apr. 19, 2012 in the names of Eric William Snyder, Lloyd Sutton Hawes II and Hon Seng Long and entitled “APPARATUS, METHOD AND ARTICLE TO AUTOMATE AND MANAGE COMMUNICATIONS IN A NETWORKED ENVIRONMENT” (Atty. Docket No. 930140.409) are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A processor-based method of operation to manage communications between devices operated by a number of agents or brokers of each of a plurality of insurance agencies or brokerages and devices operated by a number of underwriters of each of a plurality of insurance carriers, the method comprising:
detecting, by at least one processor, a change to at least one electronic document related to a proposed management policy;
for each of a plurality of underwriters, reviewing a respective status of the underwriter with respect to the proposed management policy via the at least one processor;
automatically determining, by the at least one processor, which of the plurality of underwriters to update with the change to the electronic document to produce determined underwriters, the determining based at least in part on the respective status of the underwriter with respect to the proposed management policy; and
conditionally automatically sending the change to the electronic document only to the determined underwriters by the at least one processor.

2. The method of claim 1 wherein detecting a change to at least one electronic document related to a proposed policy includes receiving a change from one of the devices operated by one or the agents or brokers, and wherein conditionally propagating the change to the electronic document only to the determined underwriters includes propagating the change to a number of the devices operated by the underwriters.

3. The method of claim 1 wherein reviewing a respective status of the underwriter with respect to the proposed management policy via the at least one processor includes determining whether the underwriter has declined the proposed management policy.

4. The method of claim 1 wherein reviewing a respective status of the underwriter with respect to the proposed management policy via the at least one processor includes determining whether the underwriter has already been bound with respect to the proposed management policy.

5. The method of claim 1 wherein conditionally sending the change to the electronic document only to the determined underwriters by the at least one processor includes pushing an electronic document with changes to only the determined underwriters and not to any other of the plurality of underwriters.

6. The method of claim 1 wherein conditionally sending the change to the electronic document only to the determined underwriters by the at least one processor includes electronically notifying the determined underwriters of an availability of the changed electronic document and not any other of the plurality of underwriters.

7. The method of claim 1 wherein conditionally sending the change to the electronic document only to the determined underwriters by the at least one processor includes propagating a new version of the electronic document, the new version including the change.

8. The method of claim 1, further comprising:
causing a display of a number of user selectable icons which allow an end user to select among a plurality of versions of the electronic document.

9. The method of claim 8 wherein causing a display of a number of user selectable icons which allow an end user to select among a plurality of versions of the electronic document includes providing a markup language page from the insurance management system to at least one of the devices operated by at least one of the determined underwriters.

10. The method of claim 1, further comprising:
causing a display of a number of user selectable icons in a document panel of a user interface which allow an end user to select among a plurality of versions of the electronic document; the document panel displayed concurrently with a message panel of the user interface.

11. The method of claim 1, further comprising:
in response to a movement of a user interface element that represents a changed version of the electronic document to a defined area of a user interface for posting documents, automatically determining which of the plurality of underwriters with which a previous version of the electronic document has been shared for the proposed management policy, before reviewing the respective status of each of the underwriters with respect to the proposed management policy.

12. An insurance management system to manage communications between devices operated by a number of agents or brokers of each of a plurality of insurance agencies or brokerages and devices operated by a number of underwriters of each of a plurality of insurance carriers, the insurance management system including at least one processor, at least one nontransitory computer-readable medium communicatively coupled to the at least one processor, and a plurality of communications ports to provide communications with the devices operated by the underwriters and the agents or brokers, the insurance management system comprising:
at least one processor;
at least one nontransitory computer-readable medium communicatively coupled to the at least one processor, and
a plurality of communications ports to provide communications with the devices operated by the underwriters and the agents or brokers, wherein:
the insurance management system detects a change to at least one electronic document related to a proposed management policy at the insurance management system;
for each of a plurality of underwriters, the at least one processor reviews a respective status of the underwriter with respect to the proposed management policy via the at least one processor;
the at least one processor automatically determines which of the plurality of underwriters to update with the change to the electronic document based at least in part on the respective status of the underwriter with respect to the proposed management policy; and
the insurance management system conditionally automatically sends the change to the electronic document only to the determined underwriters.

13. The insurance management system of claim 12 wherein the insurance management system receives the detected change from one of the devices operated by one or the agents or brokers, and sends the change to a number of the devices operated by the underwriters.

14. The insurance management system of claim 12 wherein the at least one processor determines whether the underwriter has declined the management policy to, at least in part, review the respective status of the underwriter with respect to the proposed management policy.

15. The insurance management system of claim 12 wherein the at least one processor determines whether the underwriter has already been bound with respect to the policy to review the respective status of the underwriter with respect to the proposed management policy.

16. The insurance management system of claim 12 wherein the insurance management system pushes an electronic document with changes to only the determined underwriters and not to any other of the plurality of underwriters.

17. The insurance management system of claim 12 wherein the insurance management system electronically notifies the determined underwriters of an availability of the changed electronic document and not any other of the plurality of underwriters.

18. The insurance management system of claim 12 wherein the insurance management system sends a new version of the electronic document, the new version including the change.

19. The insurance management system of claim 12 wherein the insurance management system further causes a display of a number of user selectable icons which allow an end user to select among a plurality of versions of the electronic document.

20. The insurance management system of claim 12 wherein the insurance management system further provides a markup language page from the insurance management system to at least one of the devices operated by at least one of the determined underwriters.

21. The insurance management system of claim 12 wherein the insurance management system further causes a display of a number of user selectable icons in a document panel of a user interface which allow an end user to select among a plurality of versions of the electronic document; the document panel displayed concurrently with a message panel of the user interface.

22. The insurance management system of claim 12 wherein in response to a movement of a user interface element that represents a changed version of the electronic document to a defined area of a user interface for posting documents, the at least one processor automatically determines which of the plurality of underwriters with which a previous version of the electronic document has been shared for the proposed management policy, before the at least one processor reviews the respective status of each of the underwriters with respect to the proposed management policy.

23. A processor-based method of operation to manage communications between devices operated by a number of agents or brokers of each of a plurality of insurance agencies or brokerages and devices operated by a number of underwriters of each of a plurality of insurance carriers, the method comprising:
detecting, by at least one processor, a change to at least one electronic document related to a proposed insurance management policy;
for each of a plurality of underwriters, reviewing a respective status of the underwriter with respect to the proposed insurance management policy via the at least one processor;
automatically determining, by the at least one processor, which of the plurality of underwriters to update with the change to the electronic document to produce determined underwriters, the determining based at least in part on the respective status of the underwriter with respect to the proposed insurance management policy; and
conditionally automatically updating, by the at least one processor, one or more previous submissions to only the determined underwriters with the change to the electronic document.

24. An insurance management system to manage communications between devices operated by a number of agents or brokers of each of a plurality of insurance agencies or brokerages and devices operated by a number of underwriters of each of a plurality of insurance carriers, the insurance management system including at least one processor, at least one nontransitory computer-readable medium communicatively coupled to the at least one processor, and a plurality of communications ports to provide communications with the devices operated by the underwriters and the agents or brokers, the insurance management system comprising:
at least one processor;
at least one nontransitory computer-readable medium communicatively coupled to the at least one processor, and
a plurality of communications ports to provide communications with the devices operated by the underwriters and the agents or brokers, wherein:
the insurance management system detects a change to at least one electronic document related to a proposed management policy at the insurance management system;
for each of a plurality of underwriters, the at least one processor reviews a respective status of the underwriter with respect to the proposed management policy via the at least one processor;
the at least one processor automatically determines which of the plurality of underwriters to update with the change to the electronic document based at least in part on the respective status of the underwriter with respect to the proposed management policy; and
the insurance management system conditionally automatically updates one or more previous submissions to only the determined underwriters with the change to the electronic document.
